(19) United States
(12) Patent Application Publication
(10) Pub. No.: US 2026/0280634 A1
(43) Pub. Date: Sep. 17, 2026

(54) CONFIGURATION OF MULTIPLE ANTENNA PORT TRACKING REFERENCE SIGNAL GROUPS

(71) Applicant: QUALCOMM Incorporated, San Diego, CA (US)

(72) Inventors: Jing LEI, San Diego, CA (US); Yu ZHANG, San Diego, CA (US); Jing SUN, San Diego, CA (US)

(21) Appl. No.: 19/078,030

(22) Filed: Mar. 12, 2025

(51) Int. Cl. H04B 7/06; H04W 72/0446

(52) U.S. Cl. CPC H04B 7/0626; H04B 7/0632; H04B 7/06968; H04W 72/0446

(57) ABSTRACT

Systems and techniques are provided for wireless communications. For example, a network entity can receive configuration information associated with a tracking reference signal (TRS) group comprising multiple antenna ports. The network entity can obtain, based on the configuration information, one or more measurements of a transmitted TRS signal corresponding to the TRS group, wherein the one or more measurements include a respective frequency domain (FD) correlation for each antenna port of the multiple antenna ports. The network entity can transmit, based on the configuration information, a channel state information (CSI) report corresponding to the TRS group, wherein the CSI report includes respective CSI feedback for one or more antenna ports of the multiple antenna ports, and wherein the respective CSI feedback corresponds to the respective FD correlation for each antenna port of the one or more antenna ports.

### INTRODUCTION

Aspects of the present disclosure generally relate to wireless communication. In some implementations, examples are described for channel selection and/or precoder selection associated with a configured multi-port (e.g., multiple antenna port) tracking reference signal (TRS) group.

Wireless communications systems are deployed to provide various telecommunication services, including telephony, video, data, messaging, broadcasts, among others. Wireless communications systems have developed through various generations, including a first-generation analog wireless phone service (1G), a second-generation (2G) digital wireless phone service (including interim 2.5G networks), a third-generation (3G) high speed data, Internet-capable wireless service, a fourth-generation (4G) service (e.g., Long-Term Evolution (LTE), WiMax), and a fifth-generation (5G) service (e.g., New Radio (NR)). There are presently many different types of wireless communications systems in use, including cellular and personal communications service (PCS) systems. Examples of known cellular systems include the cellular Analog Advanced Mobile Phone System (AMPS), and digital cellular systems based on code division multiple access (CDMA), frequency division multiple access (FDMA), time division multiple access (TDMA), the Global System for Mobile communication (GSM), etc.

### SUMMARY

The following presents a simplified summary relating to one or more aspects disclosed herein. Thus, the following summary should not be considered an extensive overview relating to all contemplated aspects, nor should the following summary be considered to identify key or critical elements relating to all contemplated aspects or to delineate the scope associated with any particular aspect. Accordingly, the following summary has the sole purpose to present certain concepts relating to one or more aspects relating to the mechanisms disclosed herein in a simplified form to precede the detailed description presented below.

Disclosed are systems, methods, apparatuses, and computer-readable media for performing wireless communication. According to at least one illustrative example, a network entity for wireless communication is provided. The network entity includes at a processing system, where the processing system is configured to: receive configuration information associated with a tracking reference signal (TRS) group, wherein the TRS group comprises multiple antenna ports; obtain, based on the configuration information, one or more measurements of a transmitted TRS signal corresponding to the TRS group, wherein the one or more measurements include a respective frequency domain (FD) correlation for each antenna port of the multiple antenna ports; and transmit, based on the configuration information, a channel state information (CSI) report corresponding to the TRS group, wherein the CSI report includes respective CSI feedback for one or more antenna ports of the multiple antenna ports, and wherein the respective CSI feedback corresponds to the respective FD correlation for each antenna port of the one or more antenna ports.

In another example, a method for wireless communication is provided, the method including: receiving configuration information associated with a tracking reference signal (TRS) group, wherein the TRS group comprises multiple antenna ports; obtaining, based on the configuration information, one or more measurements of a transmitted TRS signal corresponding to the TRS group, wherein the one or more measurements include a respective frequency domain (FD) correlation for each antenna port of the multiple antenna ports; and transmitting, based on the configuration information, a channel state information (CSI) report corresponding to the TRS group, wherein the CSI report includes respective CSI feedback for one or more antenna ports of the multiple antenna ports, and wherein the respective CSI feedback corresponds to the respective FD correlation for each antenna port of the one or more antenna ports.

In another example, a non-transitory computer-readable storage medium is provided comprising instructions stored thereon which, when executed by at least one processor, causes the at least one processor to: receive configuration information associated with a tracking reference signal (TRS) group, wherein the TRS group comprises multiple antenna ports; obtain, based on the configuration information, one or more measurements of a transmitted TRS signal corresponding to the TRS group, wherein the one or more measurements include a respective frequency domain (FD) correlation for each antenna port of the multiple antenna ports; and transmit, based on the configuration information, a channel state information (CSI) report corresponding to the TRS group, wherein the CSI report includes respective CSI feedback for one or more antenna ports of the multiple antenna ports, and wherein the respective CSI feedback corresponds to the respective FD correlation for each antenna port of the one or more antenna ports.

In another example, an apparatus is provided for wireless communication. The apparatus includes: means for receiving configuration information associated with a tracking reference signal (TRS) group, wherein the TRS group comprises multiple antenna ports; means for obtaining, based on the configuration information, one or more measurements of a transmitted TRS signal corresponding to the TRS group, wherein the one or more measurements include a respective frequency domain (FD) correlation for each antenna port of the multiple antenna ports; and means for transmitting, based on the configuration information, a channel state information (CSI) report corresponding to the TRS group, wherein the CSI report includes respective CSI feedback for one or more antenna ports of the multiple antenna ports, and wherein the respective CSI feedback corresponds to the respective FD correlation for each antenna port of the one or more antenna ports.

Aspects generally include a method, apparatus, system, computer program product, non-transitory computer-readable medium, user equipment, base station, wireless communication device, and/or processing system as substantially described herein with reference to and as illustrated by the drawings and specification. The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages, will be better understood from the following description when considered in connection with the accompanying figures. Each of the figures is provided for the purposes of illustration and description, and not as a definition of the limits of the claims.

While aspects are described in the present disclosure by illustration to some examples, those skilled in the art will understand that such aspects may be implemented in many different arrangements and scenarios. Techniques described herein may be implemented using different platform types, devices, systems, shapes, sizes, and/or packaging arrangements. For example, some aspects may be implemented via integrated chip implementations or other non-module-component based devices (e.g., end-user devices, vehicles, communication devices, computing devices, industrial equipment, retail/purchasing devices, medical devices, and/or artificial intelligence devices). Aspects may be implemented in chip-level components, modular components, non-modular components, non-chip-level components, device-level components, and/or system-level components. Devices incorporating described aspects and features may include additional components and features for implementation and practice of claimed and described aspects. For example, transmission and reception of wireless signals may include one or more components for analog and digital purposes (e.g., hardware components including antennas, radio frequency (RF) chains, power amplifiers, modulators, buffers, processors, interleavers, adders, and/or summers). It is intended that aspects described herein may be practiced in a wide variety of devices, components, systems, distributed arrangements, and/or end-user devices of varying size, shape, and constitution.

Other objects and advantages associated with the aspects disclosed herein will be apparent to those skilled in the art based on the accompanying drawings and detailed description. This summary is not intended to identify key or essential features of the claimed subject matter, nor is it intended to be used in isolation to determine the scope of the claimed subject matter. The subject matter should be understood by reference to appropriate portions of the entire specification of this patent, any or all drawings, and each claim. The foregoing, together with other features and aspects, will become more apparent upon referring to the following specification, claims, and accompanying drawings.

### BRIEF DESCRIPTION OF THE DRAWINGS

The accompanying drawings are presented to aid in the description of various aspects of the disclosure and are provided solely for illustration of the aspects and not limitation thereof. So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a block diagram illustrating an example of a wireless communication network, in accordance with some examples;

FIG. 2 is a diagram illustrating a design of a base station and a User Equipment (UE) device that enable transmission and processing of signals exchanged between the UE and the base station, in accordance with some examples;

FIG. 3 is a diagram illustrating an example of a disaggregated base station, in accordance with some examples;

FIG. 4 is a block diagram illustrating components of a user equipment (UE), in accordance with some examples;

FIG. 5 is a diagram illustrating an example of physical channels and reference signals in a wireless network, in accordance with some examples;

FIG. 6A is a diagram illustrating an example of consecutive symbol mapping for a multi-port tracking reference signal (TRS) group, in accordance with some examples;

FIG. 6B is a diagram illustrating an example of distributed symbol mapping for a multi-port TRS group, in accordance with some examples;

FIG. 7 is a flow diagram illustrating an example of a process for wireless communication, in accordance with some examples; and

FIG. 8 is a block diagram illustrating an example of a computing system, in accordance with some examples.

### DETAILED DESCRIPTION

Certain aspects of this disclosure are provided below for illustration purposes. Alternate aspects may be devised without departing from the scope of the disclosure. Additionally, well-known elements of the disclosure will not be described in detail or will be omitted so as not to obscure the relevant details of the disclosure. Some of the aspects described herein may be applied independently and some of them may be applied in combination as would be apparent to those of skill in the art. In the following description, for the purposes of explanation, specific details are set forth in order to provide a thorough understanding of aspects of the application. However, it will be apparent that various aspects may be practiced without these specific details. The figures and description are not intended to be restrictive.

The ensuing description provides example aspects only, and is not intended to limit the scope, applicability, or configuration of the disclosure. Rather, the ensuing description of the example aspects will provide those skilled in the art with an enabling description for implementing an example aspect. It should be understood that various changes may be made in the function and arrangement of elements without departing from the scope of the application as set forth in the appended claims.

Wireless communication networks can be deployed to provide various communication services, such as voice, video, packet data, messaging, broadcast, any combination thereof, or other communication services. A wireless communication network may support both access links and sidelinks for communication between wireless devices. An access link may refer to any communication link between a client device (e.g., a user equipment (UE), a station (STA), or other client device) and a base station (e.g., a 3GPP gNB for 5G/NR, a 3GPP eNB for 4G/LTE, a Wi-Fi access point (AP), or other base station). For example, an access link may support uplink signaling, downlink signaling, connection procedures, etc. An example of an access link is a Uu link or interface (also referred to as an NR-Uu) between a 3GPP gNB and a UE.

In some wireless communications systems, base stations may transmit synchronization signals and reference signals over a carrier to assist UEs with cell acquisition as well as frequency and time tracking of the carrier. For example, synchronization signals may allow UEs to detect a cell transmitted over a carrier. Synchronization signals may also allow the UEs to detect the center frequency of the carrier and achieve synchronization at the transmission time interval or symbol level. In some cases, for robust reception and demodulation across a system bandwidth, the UEs may also maintain tracking loops using reference signals that span a larger portion of the system bandwidth. Some base stations may continuously transmit reference signals such as cell reference signals (CRS) within a subset of resources of each resource block across the system bandwidth. Continuous transmission of reference signals may increase UE power consumption and in some cases may be an inefficient use of network resources, for example when no UEs are connected to or tracking timing for a cell associated with the base station. UE power consumption may also increase with the relative amount of time during which the UE is receiving reference signal transmissions.

In some examples, wireless communication networks may use one or more reference signals to maintain time and frequency synchronization between various devices communicating on the network. For example, in 4G LTE, base stations may transmit a cell-specific reference signal in each slot and resource block, where UEs within range of the 4G LTE base station configured to perform time tracking and/or frequency tracking using a received cell-specific reference signal to maintain time and frequency synchronization with the base station. In some examples, 5G NR wireless communication networks do not similarly transmit a cell-specific reference signal in every slot and resource block. In 5G NR, a base station may transmit a tracking reference signal (TRS) that a UE may use for time tracking and/or frequency tracking to maintain time and frequency synchronization with the base station.

A TRS can be a reference signal that may be used for time tracking, frequency tracking, or both. A base station may transmit at least one TRS in a cell provided by the base station, and one or more UEs may receive and use the TRS to perform synchronization and/or tracking to communicate with the base station and/or over the provided cell of the network. In some examples, a 5G NR TRS is configured as a downlink reference signal for providing time and frequency tracking at one or more UEs. UEs may, in some examples, use the TRS to perform phase noise compensation in higher-frequency bands (e.g., mmWave, etc.), to perform time synchronization for alignment with the transmission timing of a base station (e.g., gNB, etc.), associated with the TRS, to perform frequency synchronization corresponding to compensation for a carrier frequency offset, channel estimation for relatively high Doppler scenarios, etc.

TRS transmission may be performed periodically and/or aperiodically in the downlink. TRS transmissions can be performed independently from various physical downlink shared channel (PDSCH) transmission, and can be used for tracking across multiple slots. As noted above, a 5G NR system may use TRS for time-frequency tracking for synchronization. In some cases, a 5G NR system may use TRS for power delay profile (PDP) tracking associated with or corresponding to channel estimation.

For example, in 5G NR, power delay profile (PDP) estimation can be performed based on synchronization signal blocks (SSBs) and/or TRS. PDP estimation can correspond to estimating time-domain characteristics of a multipath wireless channel, based on measurements of received power over different delay taps. In some examples, the transmission (and corresponding reception) of a TRS at a configured interval can be used by a UE to measure the time delays of different multipath components. For example, based on correlating received TRS signals with the respective expected sequence information for the received TRS signals, the UE can determine the time-of-arrival for each multipath component, and can form an estimate of the PDP from the multi-path component time of arrival information. In some cases, a UE can use periodic and/or aperiodic TRS receptions over time to estimate the PDP, based on using the TRS receptions to determine a channel response that can be used to determine the channel delay spread and/or coherence time for the PDP estimation.

In some cases, PDP estimation based on SSB and/or TRS may be inaccurate for a control or data channel. For example, PDP estimation based on SSB and/or TRS can be inaccurate for a control/data channel that is not quasi-collocated (QCL'ed) with the SSB and/or TRS. A channel that is not QCL'ed with the SSB and/or TRS may not have the same (e.g., highly correlated) channel characteristics as the SSB and/or TRS. In another example, PDP estimation based on SSB and/or TRS can be inaccurate for a control/data channel when precoding is used for a demodulation reference signal (DMRS) associated with the control/data channel(s). In some cases, PDP estimation based on SSB and/or TRS may be inaccurate for a control/data channel when the bandwidth and/or frequency domain resource allocation (FDRA) of the control/data channel is significantly different from the bandwidth and/or FDRA associated with the SSB and/or TRS.

In some examples, PDP tracking and/or PDP estimation performed based on TRS may be implemented for channels without a precoder (e.g., non-precoded channels, etc.). PDP tracking and/or PDP estimation performed based on TRS may be performed based on a configuration where the TRS is transmitted from a single antenna element (e.g. antenna array, antenna port, etc.) of a base station or other network entity (e.g., also referred to as a single-port TRS and/or single port TRS transmission, etc.).

There is a need for systems and techniques that can be used to provide PDP tracking and/or PDP estimation using TRS and pre-coded channels. There is a further need for systems and techniques that can be used to provide multiple-port TRS configurations where the TRS is transmitted using multiple antennas (e.g., multiple antenna elements, arrays, ports, etc.) of a base station or other network entity, which may also be referred to as multi-port TRS.

Systems, apparatuses, processes (also referred to as methods), and computer-readable media (collectively referred to as “systems and techniques”) are described herein that can be used to provide multi-port TRS configurations for transmission of a TRS using multiple antenna ports. In some examples, the multiple antenna ports can correspond to a TRS group, and the multi-port TRS configuration can be used for transmitting a TRS by the TRS group. The TRS group can comprise a plurality of different antenna elements (e.g., multiple antenna ports) that are used to implement a plurality of antenna ports that may be used for transmission of a TRS. In some examples, the systems and techniques can be used to provide multi-port TRS configurations for TRS transmission using a precoded channel. A precoded channel can refer to a channel where signals undergo precoding (e.g., are processed using one or more precoders and/or precoding matrices, etc.) before being transmitted over the air. For example, precoding can be implemented using multi-antenna processing techniques that are configured to optimize the signal for reception by a receiver. In some examples, the precoded channel can be a multiple input, multiple output (MIMO) channel, including a clustered MIMO channel, etc.

In some examples, the systems and techniques can be used to provide multi-port TRS configurations for TRS transmission on a MIMO channel and/or other precoded channel associated with multiple antenna ports and/or multiple transmit antennas. In some cases, using one or more precoders and/or precoding matrices to process a signal prior to transmission can correspond to changing the PDP of the effective over the air channel. For example, a linear precoder with one or more layers can change the PDP of the effective (e.g., precoded) channel according to the precoding matrix. In some cases, frequency domain correlation information can be determined for a precoded channel, based on calculating a frequency domain (FD) correlation for each transmit antenna port (e.g., Tx port) and receive antenna (e.g., Rx antenna). The FD correlation may be determined for each Tx port and Rx antenna over a subset or configured portion of the system bandwidth, and/or may be determined for each Tx port and Rx antenna over a wide band comprising the system bandwidth. For example, the FD correlation can be determined for each Tx port and Rx antenna over a narrow band subset comprising a configured quantity of resource blocks (RBs) (e.g., four RBs, 6 RBs, 8 RBs, etc.). In some cases, FD correlations can be determined based on averaging across all Rx antennas for each respective Tx port.

In some examples, the multi-port TRS configurations can be implemented based on FD correlations that are determined per Tx port without averaging across all Rx antennas (e.g., based on FD correlations determined for each different pair of Tx port and Rx antenna). In some examples, the multi-port TRS configurations can be implemented based on FD correlations that are determined per Tx port with averaging across all Rx antennas (e.g., based on a respective averaged FD correlation determined for each Tx port, where the respective averaged FD correlation for a particular Tx port is the average of the FD correlation between the particular Tx port and each respective one of the set of Rx antennas).

In some cases, the effective precoded channel corresponding to a strongest eigenmode can have the strongest FD correlation. The effective precoded channel with the strongest FD correlation can be the effective precoded channel with the shortest time delay spread (e.g., shortest span of the PDP), based on an inverse relationship between the FD correlation of an effective precoded channel and the time delay spread and PDP span of the effective precoded channel. For example, the effective precoded channel corresponding to a weakest eigenmode can have the weakest FD correlation, and the longest time delay spread (e.g., longest PDP span). In some examples, when TRS is transmitted from N_{T} antenna elements with equal weight 1\sqrt{N_{T}}, the corresponding FD correlation can match the strongest eigenmode. In examples where TRS is transmitted from a single antenna element without beamforming, the average delay spread may be determined based on (e.g., derived from, etc.) the FD correlation, and can be used as a lower bound for the weakest eigenmode.

In some examples, the systems and techniques can be used to provide multi-port TRS transmission and/or multi-port configurations for TRS. Based on determining or obtaining FD correlation information for a precoded channel associated with multiple antenna ports (e.g., multiple Tx ports), the systems and techniques can be configured to use the FD correlation to estimate and/or determine information of the effective channel without (e.g., before) performing transmission and/or reception on the effective channel.

Further aspects of the systems and techniques will be described with respect to the figures.

As used herein, the phrase “based on” shall not be construed as a reference to a closed set of information, one or more conditions, one or more factors, or the like. In other words, the phrase “based on A” (where “A” may be information, a condition, a factor, or the like) shall be construed as “based at least on A” unless specifically recited differently.

As used herein, the terms “user equipment” (UE) and “network entity” are not intended to be specific or otherwise limited to any particular radio access technology (RAT), unless otherwise noted. In general, a UE may be any wireless communication device (e.g., a mobile phone, router, tablet computer, laptop computer, and/or tracking device, etc.), wearable (e.g., smartwatch, smart-glasses, wearable ring, and/or an extended reality (XR) device such as a virtual reality (VR) headset, an augmented reality (AR) headset or glasses, or a mixed reality (MR) headset), vehicle (e.g., automobile, motorcycle, bicycle, etc.), aircraft (e.g., an airplane, jet, unmanned aerial vehicle (UAV) or drone, helicopter, airship, glider, etc.), and/or Internet of Things (IoT) device, etc., used by a user to communicate over a wireless communications network. A UE may be mobile or may (e.g., at certain times) be stationary, and may communicate with a radio access network (RAN). As used herein, the term “UE” may be referred to interchangeably as an “access terminal” or “AT,” a “client device,” a “wireless device,” a “subscriber device,” a “subscriber terminal,” a “subscriber station,” a “user terminal” or “UT,” a “mobile device,” a “mobile terminal,” a “mobile station,” or variations thereof. Generally, UEs can communicate with a core network via a RAN, and through the core network the UEs can be connected with external networks such as the Internet and with other UEs. Of course, other mechanisms of connecting to the core network and/or the Internet are also possible for the UEs, such as over wired access networks, wireless local area network (WLAN) networks (e.g., based on IEEE 802.11 communication standards, etc.), and so on.

A network entity can be implemented in an aggregated or monolithic base station architecture, or alternatively, in a disaggregated base station architecture, and may include one or more of a central unit (CU), a distributed unit (DU), a radio unit (RU), a Near-Real Time (Near-RT) RAN Intelligent Controller (RIC), or a Non-Real Time (Non-RT) RIC. A base station (e.g., with an aggregated/monolithic base station architecture or disaggregated base station architecture) may operate according to one of several RATs in communication with UEs depending on the network in which it is deployed, and may be alternatively referred to as an access point (AP), a network node, a NodeB (NB), an evolved NodeB (eNB), a next generation eNB (ng-eNB), a New Radio (NR) Node B (also referred to as a gNB or gNodeB), etc. A base station may be used primarily to support wireless access by UEs, including supporting data, voice, and/or signaling connections for the supported UEs. In some systems, a base station may provide edge node signaling functions while in other systems it may provide additional control and/or network management functions. A communication link through which UEs can send signals to a base station is called an uplink (UL) channel (e.g., a reverse traffic channel, a reverse control channel, an access channel, etc.). A communication link through which the base station can send signals to UEs is called a downlink (DL) or forward link channel (e.g., a paging channel, a control channel, a broadcast channel, or a forward traffic channel, etc.). The term traffic channel (TCH), as used herein, can refer to either an uplink, reverse or downlink, and/or a forward traffic channel.

The term “network entity” or “base station” (e.g., with an aggregated/monolithic base station architecture or disaggregated base station architecture) may refer to a single physical transmit receive point (TRP) or to multiple physical TRPs that may or may not be co-located. For example, where the term “network entity” or “base station” refers to a single physical TRP, the physical TRP may be an antenna of the base station corresponding to a cell (or several cell sectors) of the base station. Where the term “network entity” or “base station” refers to multiple co-located physical TRPs, the physical TRPs may be an array of antennas (e.g., as in a multiple-input multiple-output (MIMO) system or where the base station employs beamforming) of the base station. Where the term “base station” refers to multiple non-co-located physical TRPs, the physical TRPs may be a distributed antenna system (DAS) (e.g., a network of spatially separated antennas connected to a common source via a transport medium) or a remote radio head (RRH) (e.g., a remote base station connected to a serving base station). Alternatively, the non-co-located physical TRPs may be the serving base station receiving the measurement report from the UE and a neighbor base station whose reference radio frequency (RF) signals (e.g., or simply “reference signals”) the UE is measuring. Because a TRP is the point from which a base station transmits and receives wireless signals, as used herein, references to transmission from or reception at a base station are to be understood as referring to a particular TRP of the base station.

In some implementations that support positioning of UEs, a network entity or base station may not support wireless access by UEs (e.g., may not support data, voice, and/or signaling connections for UEs), but may instead transmit reference signals to UEs to be measured by the UEs, and/or may receive and measure signals transmitted by the UEs. Such a base station may be referred to as a positioning beacon (e.g., when transmitting signals to UEs) and/or as a location measurement unit (e.g., when receiving and measuring signals from UEs).

As described herein, a node (which may be referred to as a node, a network node, a network entity, or a wireless node) may include, be, or be included in (e.g., be a component of) a base station (e.g., any base station described herein), a UE (e.g., any UE described herein), a network controller, an apparatus, a device, a computing system, a processing system, an integrated access and backhauling (IAB) node, a distributed unit (DU), a central unit (CU), a remote unit (RU), and/or another processing entity configured to perform any of the techniques described herein. For example, a network node may be a UE. As another example, a network node may be a base station or network entity. As another example, a first network node may be configured to communicate with a second network node or a third network node. In one aspect of this example, the first network node may be a UE, the second network node may be a base station, and the third network node may be a UE. In another aspect of this example, the first network node may be a UE, the second network node may be a base station, and the third network node may be a base station. In yet other aspects of this example, the first, second, and third network nodes may be different relative to these examples. Similarly, reference to a UE, base station, apparatus, device, computing system, processing system, or the like may include disclosure of the UE, base station, apparatus, device, computing system, processing system, or the like being a network node. For example, disclosure that a UE is configured to receive information from a base station also discloses that a first network node is configured to receive information from a second network node. Consistent with this disclosure, once a specific example is broadened in accordance with this disclosure (e.g., a UE is configured to receive information from a base station also discloses that a first network node is configured to receive information from a second network node), the broader example of the narrower example may be interpreted in the reverse, but in a broad open-ended way. In the example above where a UE is configured to receive information from a base station also discloses that a first network node is configured to receive information from a second network node, the first network node may refer to a first UE, a first base station, a first apparatus, a first device, a first computing system, a first processing system, a first one or more components, a first processing entity, or the like configured to receive the information; and the second network node may refer to a second UE, a second base station, a second apparatus, a second device, a second computing system, a second processing system, a second one or more components, a second processing entity, or the like.

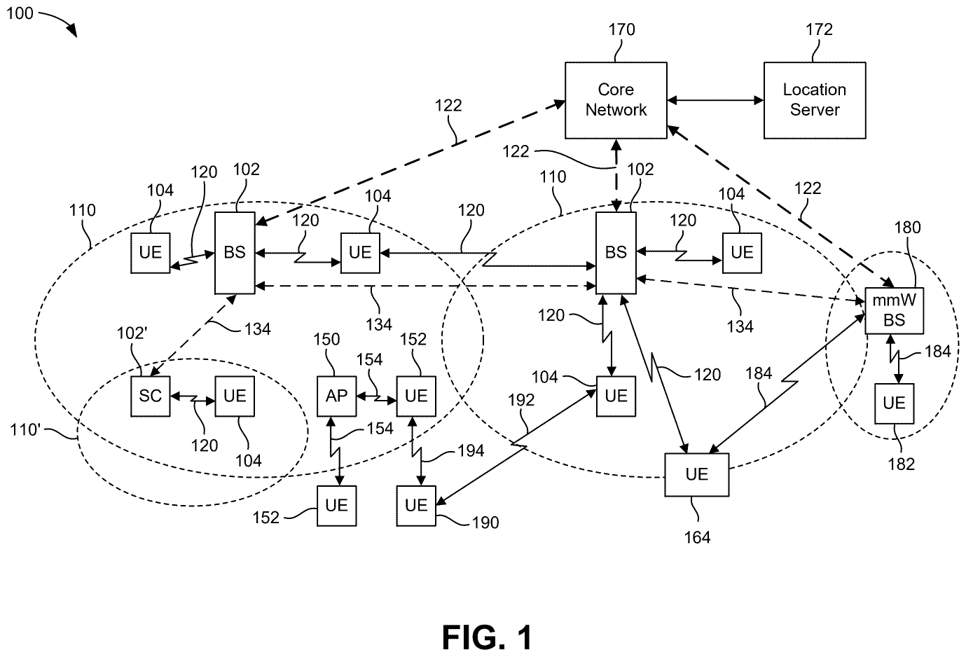

As described herein, a network entity (which may alternatively be referred to as an entity, a node, a network node, or a wireless entity) may be, be similar to, include, or be included in (e.g., be a component of) a base station (e.g., any base station described herein, including a disaggregated base station), a UE (e.g., any UE described herein), a reduced capability (RedCap) device, an enhanced reduced capability (eRedCap) device, an ambient internet-of-things (IoT) device, an energy harvesting (EH)-capable device, a network controller, an apparatus, a device, a computing system, a processing system, an integrated access and backhauling (IAB) node, a distributed unit (DU), a central unit (CU), a remote/radio unit (RU) (which may also be referred to as a remote radio unit (RRU)), and/or another processing entity configured to perform any of the techniques described herein. For example, a network entity may be a UE. As another example, a network entity may be a base station. As used herein, “network entity” may refer to an entity that is configured to operate in a network, such as the network 100 of FIG. 1. For example, a “network entity” is not limited to an entity that is currently located in and/or currently operating in the network. Rather, a network entity may be any entity that is capable of communicating and/or operating in the network.

The adjectives “first,” “second,” “third,” and so on are used for contextual distinction between two or more of the modified noun in connection with a discussion and are not meant to be absolute modifiers that apply only to a certain respective entity throughout the entire document. For example, a network entity may be referred to as a “first network entity” in connection with one discussion and may be referred to as a “second network entity” in connection with another discussion, or vice versa. As an example, a first network entity may be configured to communicate with a second network entity or a third network entity. In one aspect of this example, the first network entity may be a UE, the second network entity may be a base station, and the third network entity may be a UE. In another aspect of this example, the first network entity may be a UE, the second network entity may be a base station, and the third network entity may be a base station. In yet other aspects of this example, the first, second, and third network entities may be different relative to these examples.

Similarly, reference to a UE, base station, network node, apparatus, device, computing system, processing system or the like may include disclosure of the UE, base station, network node, apparatus, device, computing system, processing system or the like being a network entity. For example, disclosure that a UE is configured to receive information from a base station also discloses that a first network entity is configured to receive information from a second network entity. Consistent with this disclosure, once a specific example is broadened in accordance with this disclosure (e.g., a UE is configured to receive information from a base station also discloses that a first network entity is configured to receive information from a second network entity), the broader example of the narrower example may be interpreted in the reverse, but in a broad open-ended way. In the example above where a UE is configured to receive information from a base station also discloses that a first network entity is configured to receive information from a second network entity, the first network entity may refer to a first UE, a first base station, a first apparatus, a first device, a first computing system, a first processing system, a first set of one or more one or more components, a first processing entity, or the like configured to receive the information; and the second network entity may refer to a second UE, a second base station, a second apparatus, a second device, a second computing system, a second processing system, a second set of one or more components, a second processing entity, or the like.

As described herein, communication of information (e.g., any information, signal, or the like) may be described in various aspects using different terminology. Disclosure of one communication term includes disclosure of other communication terms. For example, a first network entity may be described as being configured to transmit information to a second network entity. In this example and consistent with this disclosure, disclosure that the first network entity is configured to transmit information to the second network entity includes disclosure that the first network entity is configured to provide, send, output, communicate, or transmit information to the second network entity. Similarly, in this example and consistent with this disclosure, disclosure that the first network entity is configured to transmit information to the second network entity includes disclosure that the second network entity is configured to receive, obtain, or decode the information that is provided, sent, output, communicated, or transmitted by the first network entity.

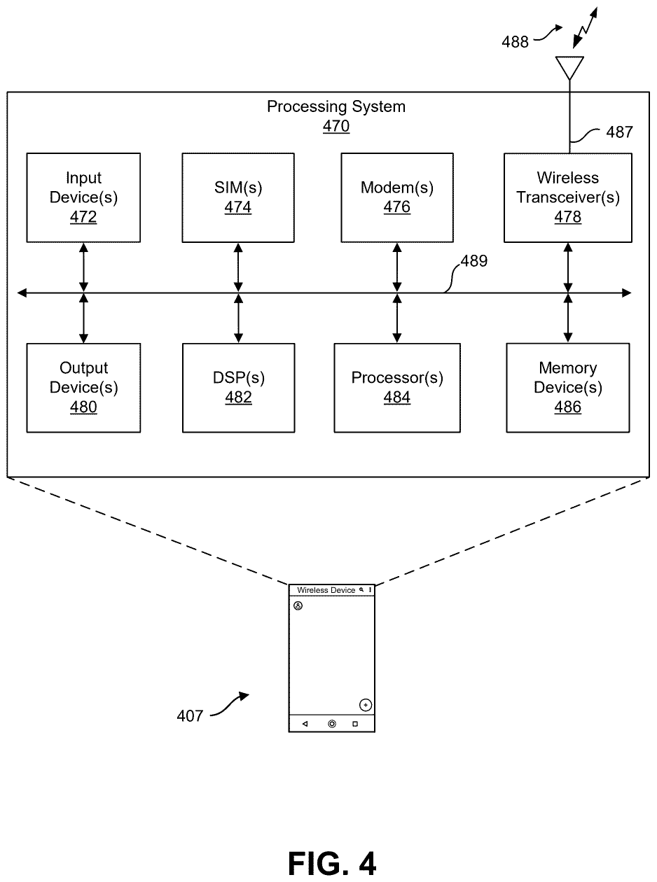

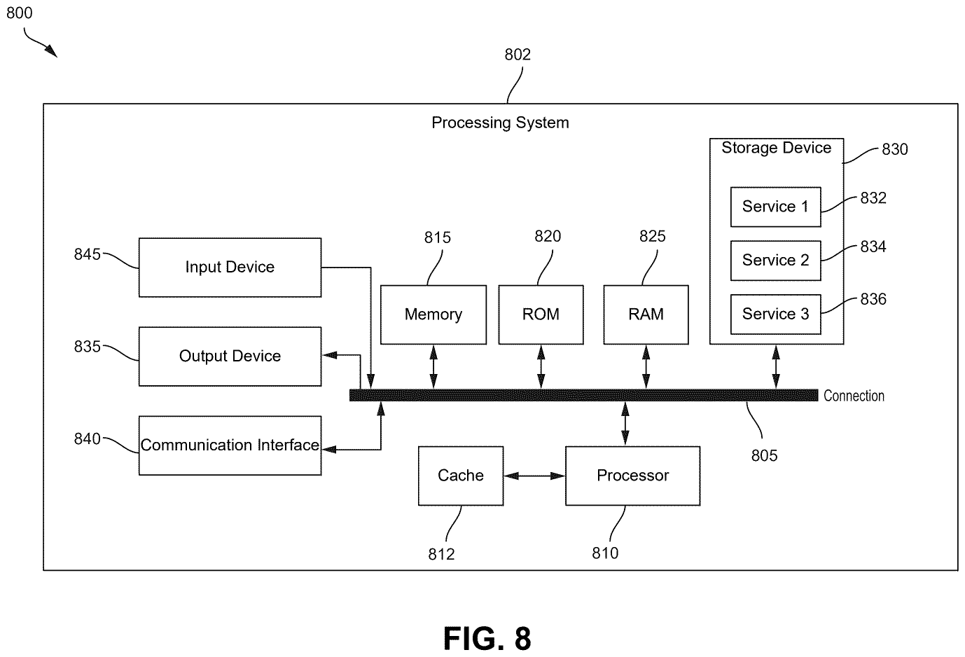

In some examples, the network entity 102 may include a processing system (e.g., such as the processing system 470 of FIG. 4 and/or the processing system 802 of FIG. 8, etc.). Similarly, the network entity 180 (e.g., a millimeter wave (mmW) base station, etc.) may include a respective processing system (e.g., such as the processing system 470 of FIG. 4 and/or the processing system 802 of FIG. 8, etc.). A processing system may include one or more components (or subcomponents), such as one or more components described herein. For example, a respective component of the one or more components may be, be similar to, include, or be included in at least one memory, at least one communication interface, or at least one processor. For example, a processing system may include one or more components. In such an example, the one or more components may include a first component, a second component, and a third component. In this example, the first component may be coupled to a second component and a third component. In this example, the first component may be at least one processor, the second component may be a communication interface, and the third component may be at least one memory. A processing system may generally be a system including one or more components that may perform one or more functions, such as any function or combination of functions described herein. For example, one or more components may receive input information (e.g., any information that is an input, such as a signal, any digital information, or any other information), one or more components may process the input information to generate output information (e.g., any information that is an output, such as a signal or any other information), one or more components may perform any function as described herein, or any combination thereof. As described herein, an “input” and “input information” may be used interchangeably. Similarly, as described herein, an “output” and “output information” may be used interchangeably. Any information generated by any component may be provided to one or more other systems or components of, for example, a network entity described herein). For example, a processing system may include a first component configured to receive or obtain information, a second component configured to process the information to generate output information, and/or a third component configured to provide the output information to other systems or components. In this example, the first component may be a communication interface (e.g., a first communication interface), the second component may be at least one processor (e.g., that is coupled to the communication interface and/or at least one memory), and the third component may be a communication interface (e.g., the first communication interface or a second communication interface). For example, a processing system may include at least one memory, at least one communication interface, and/or at least one processor, where the at least one processor may, for example, be coupled to the at least one memory and the at least one communication interface.

A processing system of a network entity described herein may interface with one or more other components of the network entity, may process information received from one or more other components (such as input information), or may output information to one or more other components. For example, a processing system may include a first component configured to interface with one or more other components of the network entity to receive or obtain information, a second component configured to process the information to generate one or more outputs, and/or a third component configured to output the one or more outputs to one or more other components. In this example, the first component may be a communication interface (e.g., a first communication interface), the second component may be at least one processor (e.g., that is coupled to the communication interface and/or at least one memory), and the third component may be a communication interface (e.g., the first communication interface or a second communication interface). For example, a chip or modem of the network entity may include a processing system. The processing system may include a first communication interface to receive or obtain information, and a second communication interface to output, transmit, or provide information. In some examples, the first communication interface may be an interface configured to receive input information, and the information may be provided to the processing system. In some examples, the second system interface may be configured to transmit information output from the chip or modem. The second communication interface may also obtain or receive input information, and the first communication interface may also output, transmit, or provide information.

An RF signal comprises an electromagnetic wave of a given frequency that transports information through the space between a transmitter and a receiver. As used herein, a transmitter may transmit a single “RF signal” or multiple “RF signals” to a receiver. However, the receiver may receive multiple “RF signals” corresponding to each transmitted RF signal due to the propagation characteristics of RF signals through multipath channels. The same transmitted RF signal on different paths between the transmitter and receiver may be referred to as a “multipath” RF signal. As used herein, an RF signal may also be referred to as a “wireless signal” or simply a “signal” where it is clear from the context that the term “signal” refers to a wireless signal or an RF signal.

Various aspects of the systems and techniques described herein will be discussed below with respect to the figures. According to various aspects, FIG. 1 illustrates an example of a wireless communications system 100. The wireless communications system 100 (e.g., which may also be referred to as a wireless wide area network (WWAN)) can include various base stations 102 and various UEs 104. In some aspects, the base stations 102 may also be referred to as “network entities” or “network nodes.” One or more of the base stations 102 can be implemented in an aggregated or monolithic base station architecture. Additionally, or alternatively, one or more of the base stations 102 can be implemented in a disaggregated base station architecture, and may include one or more of a central unit (CU), a distributed unit (DU), a radio unit (RU), a Near-Real Time (Near-RT) RAN Intelligent Controller (RIC), or a Non-Real Time (Non-RT) RIC. The base stations 102 can include macro cell base stations (e.g., high power cellular base stations) and/or small cell base stations (e.g., low power cellular base stations). In an aspect, the macro cell base station may include eNBs and/or ng-eNBs where the wireless communications system 100 corresponds to a long-term evolution (LTE) network, or gNBs where the wireless communications system 100 corresponds to a NR network, or a combination of both, and the small cell base stations may include femtocells, picocells, microcells, etc.

The base stations 102 may collectively form a RAN and interface with a core network 170 (e.g., an evolved packet core (EPC) or a 5G core (5GC)) through backhaul links 122, and through the core network 170 to one or more location servers 172 (e.g., which may be part of core network 170 or may be external to core network 170). In addition to other functions, the base stations 102 may perform functions that relate to one or more of transferring user data, radio channel ciphering and deciphering, integrity protection, header compression, mobility control functions (e.g., handover, dual connectivity), inter-cell interference coordination, connection setup and release, load balancing, distribution for non-access stratum (NAS) messages, NAS node selection, synchronization, RAN sharing, multimedia broadcast multicast service (MBMS), subscriber and equipment trace, RAN information management (RIM), paging, positioning, and delivery of warning messages. The base stations 102 may communicate with each other directly or indirectly (e.g., through the EPC or 5GC) over backhaul links 134, which may be wired and/or wireless.

The base stations 102 may wirelessly communicate with the UEs 104. Each of the base stations 102 may provide communication coverage for a respective geographic coverage area 110. In an aspect, one or more cells may be supported by a base station 102 in each coverage area 110. A “cell” is a logical communication entity used for communication with a base station (e.g., over some frequency resource, referred to as a carrier frequency, component carrier, carrier, band, or the like), and may be associated with an identifier (e.g., a physical cell identifier (PCI), a virtual cell identifier (VCI), a cell global identifier (CGI)) for distinguishing cells operating via the same or a different carrier frequency. In some cases, different cells may be configured according to different protocol types (e.g., machine-type communication (MTC), narrowband IoT (NB-IoT), enhanced mobile broadband (eMBB), or others) that may provide access for different types of UEs. Because a cell is supported by a specific base station, the term “cell” may refer to either or both of the logical communication entity and the base station that supports it, depending on the context. In addition, because a TRP is typically the physical transmission point of a cell, the terms “cell” and “TRP” may be used interchangeably. In some cases, the term “cell” may also refer to a geographic coverage area of a base station (e.g., a sector), insofar as a carrier frequency can be detected and used for communication within some portion of geographic coverage areas 110.

While neighboring macro cell base station 102 geographic coverage areas 110 may partially overlap (e.g., in a handover region), some of the geographic coverage areas 110 may be substantially overlapped by a larger geographic coverage area 110. For example, a small cell base station 102′ may have a coverage area 110′ that substantially overlaps with the coverage area 110 of one or more macro cell base stations 102. A network that includes both small cell and macro cell base stations may be known as a heterogeneous network. A heterogeneous network may also include home eNBs (HeNBs), which may provide service to a restricted group known as a closed subscriber group (CSG).

The communication links 120 between the base stations 102 and the UEs 104 may include uplink (e.g., also referred to as reverse link) transmissions from a UE 104 to a base station 102 and/or downlink (e.g., also referred to as forward link) transmissions from a base station 102 to a UE 104. The communication links 120 may use MIMO antenna technology, including spatial multiplexing, beamforming, and/or transmit diversity. The communication links 120 may be provided using one or more carrier frequencies. Allocation of carriers may be asymmetric with respect to downlink and uplink (e.g., a greater or lesser quantity of carriers may be allocated for downlink than for uplink).

Beamforming, which may also be referred to as spatial filtering, directional transmission, or directional reception, is a signal processing technique that may be used at a transmitting device or a receiving device (e.g., one or more of the base stations 102, UEs 104, etc.) to shape or steer an antenna beam (e.g., a transmit beam, a receive beam) along a spatial path between the transmitting device and the receiving device. Beamforming may be implemented based on combining the signals communicated via antenna elements of an antenna array such that some signals propagating at particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

A transmitting device and/or a receiving device (e.g., such as one or more of base stations 102 and/or UEs 104) may use beam sweeping techniques as part of beam forming operations. For example, a base station 102 (e.g., or other transmitting device) may use multiple antennas or antenna arrays (e.g., antenna panels) to conduct beamforming operations for directional communications with a UE 104 (e.g., or other receiving device). Some signals (e.g., synchronization signals, reference signals, beam selection signals, or other control signals) may be transmitted by base station 102 (or other transmitting device) multiple times in different directions. For example, the base station 102 may transmit a signal according to different beamforming weight sets associated with different directions of transmission. Transmissions in different beam directions may be used to identify (e.g., by a transmitting device, such as a base station 102, or by a receiving device, such as a UE 104) a beam direction for later transmission or reception by the base station 102.

Some signals, such as data signals associated with a particular receiving device, may be transmitted by a base station 102 in a single beam direction (e.g., a direction associated with the receiving device, such as a UE 104). In some examples, the beam direction associated with transmissions along a single beam direction may be determined based on a signal that was transmitted in one or more beam directions. For example, a UE 104 may receive one or more of the signals transmitted by the base station 102 in different directions and may report to the base station 102 an indication of the signal that the UE 104 received with a highest signal quality or an otherwise acceptable signal quality.

In some examples, transmissions by a device (e.g., by a base station 102 or a UE 104) may be performed using multiple beam directions, and the device may use a combination of digital precoding or radio frequency beamforming to generate a combined beam for transmission (e.g., from a base station 102 to a UE 104, from a transmitting device to a receiving device, etc.). The UE 104 may report feedback that indicates precoding weights for one or more beam directions, and the feedback may correspond to a configured number of beams across a system bandwidth or one or more sub-bands. The base station 102 may transmit a reference signal (e.g., a cell-specific reference signal (CRS), a channel state information reference signal (CSI-RS), etc.), which may be precoded or unprecoded. The UE 104 may provide feedback for beam selection, which may be a precoding matrix indicator (PMI) or codebook-based feedback (e.g., a multi-panel type codebook, a linear combination type codebook, a port selection type codebook). Although these techniques are described with reference to signals transmitted in one or more directions by a base station 102, a UE 104 may employ similar techniques for transmitting signals multiple times in different directions (e.g., for identifying a beam direction for subsequent transmission or reception by the UE 104) or for transmitting a signal in a single direction (e.g., for transmitting data to a receiving device).

A receiving device (e.g., a UE 104) may try multiple receive configurations (e.g., directional listening) when receiving various signals from the base station 102, such as synchronization signals, reference signals, beam selection signals, or other control signals. For example, a receiving device may try multiple receive directions by receiving via different antenna subarrays, by processing received signals according to different antenna subarrays, by receiving according to different receive beamforming weight sets (e.g., different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some examples, a receiving device may use a single receive configuration to receive along a single beam direction (e.g., when receiving a data signal). The single receive configuration may be aligned in a beam direction determined based on listening according to different receive configuration directions (e.g., a beam direction determined to have a highest signal strength, highest signal-to-noise ratio (SNR), or otherwise acceptable signal quality based on listening according to multiple beam directions).

The wireless communications system 100 may further include a WLAN AP 150 in communication with WLAN stations (STAs) 152 via communication links 154 in an unlicensed frequency spectrum (e.g., 5 Gigahertz (GHz)). When communicating in an unlicensed frequency spectrum, the WLAN STAs 152 and/or the WLAN AP 150 may perform a clear channel assessment (CCA) or listen before talk (LBT) procedure prior to communicating in order to determine whether the channel is available. In some examples, the wireless communications system 100 can include devices (e.g., UEs, etc.) that communicate with one or more UEs 104, base stations 102, APs 150, etc., utilizing the ultra-wideband (UWB) spectrum. The UWB spectrum can range from 3.1 to 10.5 GHz.

The small cell base station 102′ may operate in a licensed and/or an unlicensed frequency spectrum. When operating in an unlicensed frequency spectrum, the small cell base station 102′ may employ LTE or NR technology and use the same 5 GHz unlicensed frequency spectrum as used by the WLAN AP 150. The small cell base station 102′, employing LTE and/or 5G in an unlicensed frequency spectrum, may boost coverage to and/or increase capacity of the access network. NR in unlicensed spectrum may be referred to as NR-U. LTE in an unlicensed spectrum may be referred to as LTE-U, licensed assisted access (LAA), or MulteFire.

The wireless communications system 100 may further include a millimeter wave (mmW) base station 180 that may operate in mmW frequencies and/or near mmW frequencies in communication with a UE 182. The mmW base station 180 may be implemented in an aggregated or monolithic base station architecture, or alternatively, in a disaggregated base station architecture (e.g., including one or more of a CU, a DU, a RU, a Near-RT RIC, or a Non-RT RIC). Extremely high frequency (EHF) is part of the RF in the electromagnetic spectrum. EHF has a range of 30 GHz to 300 GHz and a wavelength between 1 millimeter and 10 millimeters. Radio waves in this band may be referred to as a millimeter wave. Near mmW may extend down to a frequency of 3 GHz with a wavelength of 100 millimeters. The super high frequency (SHF) band extends between 3 GHz and 30 GHz, also referred to as centimeter wave. Communications using the mmW and/or near mmW radio frequency band have high path loss and a relatively short range. The mmW base station 180 and the UE 182 may utilize beamforming (e.g., transmit and/or receive) over an mmW communication link 184 to compensate for the extremely high path loss and short range. Further, it will be appreciated that in alternative configurations, one or more base stations 102 may also transmit using mmW or near mmW and beamforming. Accordingly, it will be appreciated that the foregoing illustrations are merely examples and should not be construed to limit the various aspects disclosed herein.

In some aspects relating to 5G, the frequency spectrum in which wireless network nodes or entities (e.g., base stations 102/180, UEs 104/182) operate is divided into multiple frequency ranges, FR1 (e.g., from 450 to 6,000 Megahertz (MHz)), FR2 (e.g., from 24,250 to 52,600 MHz), FR3 (e.g., above 52,600 MHz), and FR4 (e.g., between FR1 and FR2). In a multi-carrier system, such as 5G, one of the carrier frequencies is referred to as the “primary carrier” or “anchor carrier” or “primary serving cell” or “PCell,” and the remaining carrier frequencies are referred to as “secondary carriers” or “secondary serving cells” or “SCells.” In carrier aggregation, the anchor carrier is the carrier operating on the primary frequency (e.g., FR1) utilized by a UE 104/182 and the cell in which the UE 104/182 either performs the initial radio resource control (RRC) connection establishment procedure or initiates the RRC connection re-establishment procedure. The primary carrier carries all common and UE-specific control channels and may be a carrier in a licensed frequency (however, this is not always the case). A secondary carrier is a carrier operating on a second frequency (e.g., FR2) that may be configured once the RRC connection is established between the UE 104 and the anchor carrier and that may be used to provide additional radio resources. In some cases, the secondary carrier may be a carrier in an unlicensed frequency. The secondary carrier may contain only necessary signaling information and signals, for example, those that are UE-specific may not be present in the secondary carrier, since both primary uplink and downlink carriers are typically UE-specific. This means that different UEs 104/182 in a cell may have different downlink primary carriers. The same is true for the uplink primary carriers. The network is able to change the primary carrier of any UE 104/182 at any time. This is done, for example, to balance the load on different carriers. Because a “serving cell” (e.g., whether a PCell or an SCell) corresponds to a carrier frequency and/or component carrier over which some base station is communicating, the term “cell,” “serving cell,” “component carrier,” “carrier frequency,” and the like can be used interchangeably.

For example, still referring to FIG. 1, one of the frequencies utilized by the macro cell base stations 102 may be an anchor carrier (or “PCell”) and other frequencies utilized by the macro cell base stations 102 and/or the mmW base station 180 may be secondary carriers (“SCells”). In carrier aggregation, the base stations 102 and/or the UEs 104 may use spectrum up to Y MHz (e.g., 5, 10, 15, 20, 100 MHz) bandwidth per carrier up to a total of Yx MHz (e.g., x component carriers) for transmission in each direction. The component carriers may or may not be adjacent to each other on the frequency spectrum. Allocation of carriers may be asymmetric with respect to the downlink and uplink (e.g., a greater or lesser quantity of carriers may be allocated for downlink than for uplink). The simultaneous transmission and/or reception of multiple carriers enables the UE 104/182 to significantly increase its data transmission and/or reception rates. For example, two 20 MHz aggregated carriers in a multi-carrier system would theoretically lead to a two-fold increase in data rate (e.g., 40 MHz), compared to that attained by a single 20 MHz carrier.

In order to operate on multiple carrier frequencies, a base station 102 and/or a UE 104 can be equipped with multiple receivers and/or transmitters. For example, a UE 104 may have two receivers, “Receiver 1” and “Receiver 2,” where “Receiver 1” is a multi-band receiver that can be tuned to band (e.g., carrier frequency) ‘X’ or band ‘Y,’ and “Receiver 2” is a one-band receiver tunable to band ‘Z’ only. In this example, if the UE 104 is being served in band ‘X,’ band ‘X’ would be referred to as the PCell or the active carrier frequency, and “Receiver 1” would need to tune from band ‘X’ to band ‘Y’ (e.g., an SCell) in order to measure band ‘Y’ (and vice versa). In contrast, whether the UE 104 is being served in band ‘X’ or band ‘Y,’ because of the separate “Receiver 2,” the UE 104 can measure band ‘Z’ without interrupting the service on band ‘X’ or band ‘Y.’

The wireless communications system 100 may further include a UE 164 that may communicate with a macro cell base station 102 over a communication link 120 and/or the mmW base station 180 over an mmW communication link 184. For example, the macro cell base station 102 may support a PCell and one or more SCells for the UE 164 and the mmW base station 180 may support one or more SCells for the UE 164.

The wireless communications system 100 may further include one or more UEs, such as UE 190, that connects indirectly to one or more communication networks via one or more device-to-device (D2D) peer-to-peer (P2P) links (e.g., referred to as “sidelinks”). In the example of FIG. 1, UE 190 has a D2D P2P link 192 with one of the UEs 104 connected to one of the base stations 102 (e.g., through which UE 190 may indirectly obtain cellular connectivity) and a D2D P2P link 194 with WLAN STA 152 connected to the WLAN AP 150 (e.g., through which UE 190 may indirectly obtain WLAN-based Internet connectivity). In an example, the D2D P2P links 192 and 194 may be supported with any well-known D2D RAT, such as LTE Direct (LTE-D), Wi-Fi Direct (Wi-Fi-D), Bluetooth®, and so on.

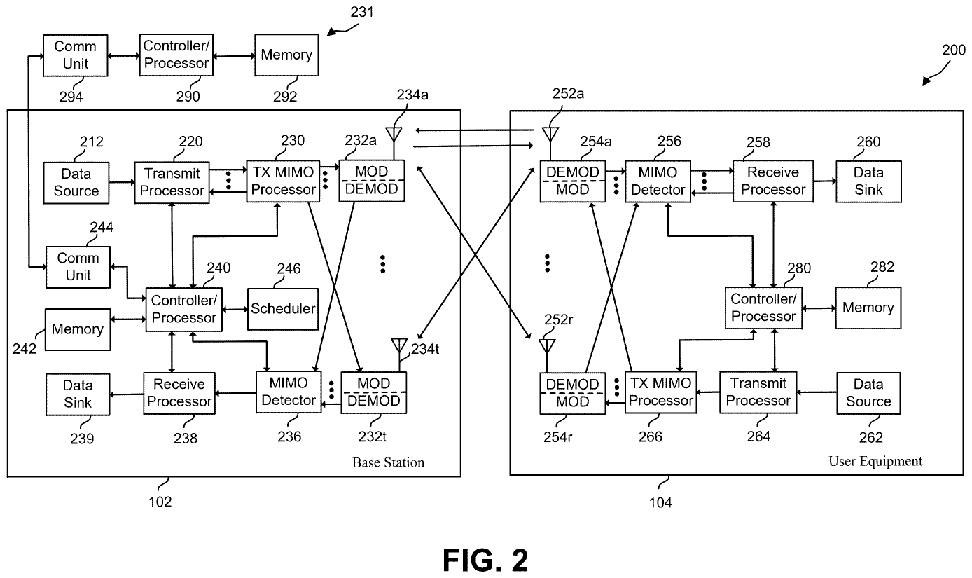

FIG. 2 illustrates a block diagram of an example architecture 200 of a base station 102 and a UE 104 that enables transmission and processing of signals exchanged between the UE and the base station, in accordance with some aspects of the present disclosure. Example architecture 200 includes components of a base station 102 and a UE 104, which may be one of the base stations 102 and one of the UEs 104 illustrated in FIG. 1. Base station 102 may be equipped with T antennas 234a through 234t, and UE 104 may be equipped with R antennas 252a through 252r, where in general T≥1 and R≥1.

At base station 102, a transmit processor 220 may receive data from a data source 212 for one or more UEs, select one or more modulation and coding schemes (MCS) for each UE based on channel quality indicators (CQIs) received from the UE, process (e.g., encode and modulate) the data for each UE based on the MCS(s) selected for the UE, and provide data symbols for all UEs. Transmit processor 220 may also process system information (e.g., for semi-static resource partitioning information (SRPI) and/or the like) and control information (e.g., CQI requests, grants, upper layer signaling, and/or the like) and provide overhead symbols and control symbols. Transmit processor 220 may also generate reference symbols for reference signals (e.g., the cell-specific reference signal (CRS)) and synchronization signals (e.g., the primary synchronization signal (PSS) and secondary synchronization signal (SSS)). A transmit (TX) multiple-input multiple-output (MIMO) processor 230 may perform spatial processing (e.g., precoding) on the data symbols, the control symbols, the overhead symbols, and/or the reference symbols, if applicable, and may provide T output symbol streams to T modulators (MODs) 232a through 232t. The modulators 232a through 232t are shown as a combined modulator-demodulator (MOD-DEMOD). In some cases, the modulators and demodulators can be separate components. Each modulator of the modulators 232a to 232t may process a respective output symbol stream (e.g., for an orthogonal frequency-division multiplexing (OFDM) scheme and/or the like) to obtain an output sample stream. Each modulator of the modulators 232a to 232t may further process (e.g., convert to analog, amplify, filter, and upconvert) the output sample stream to obtain a downlink signal. T downlink signals may be transmitted from modulators 232a to 232t via T antennas 234a through 234t, respectively. According to certain aspects described in more detail below, the synchronization signals can be generated with location encoding to convey additional information.

At UE 104, antennas 252a through 252r may receive the downlink signals from base station 102 and/or other base stations and may provide received signals to one or more demodulators (DEMODs) 254a through 254r, respectively. The demodulators 254a through 254r are shown as a combined modulator-demodulator (MOD-DEMOD). In some cases, the modulators and demodulators can be separate components. Each demodulator of the demodulators 254a through 254r may condition (e.g., filter, amplify, downconvert, and digitize) a received signal to obtain input samples. Each demodulator of the demodulators 254a through 254r may further process the input samples (e.g., for OFDM and/or the like) to obtain received symbols. A MIMO detector 256 may obtain received symbols from all R demodulators 254a through 254r, perform MIMO detection on the received symbols if applicable, and provide detected symbols. A receive processor 258 may process (e.g., demodulate and decode) the detected symbols, provide decoded data for UE 104 to a data sink 260, and provide decoded control information and system information to a controller/processor 280. A channel processor may determine reference signal received power (RSRP), received signal strength indicator (RSSI), reference signal received quality (RSRQ), channel quality indicator (CQI), and/or the like.

On the uplink, at UE 104, a transmit processor 264 may receive and process data from a data source 262 and control information (e.g., for reports comprising RSRP, RSSI, RSRQ, CQI, and/or the like) from controller/processor 280. Transmit processor 264 may also generate reference symbols for one or more reference signals (e.g., based on a beta value or a set of beta values associated with the one or more reference signals). The symbols from transmit processor 264 may be precoded by a TX-MIMO processor 266, further processed by modulators 254a through 254r (e.g., for DFT-s-OFDM, CP-OFDM, and/or the like), and transmitted to base station 102. At base station 102, the uplink signals from UE 104 and other UEs may be received by antennas 234a through 234t, processed by demodulators 232a through 232t, detected by a MIMO detector 236 (e.g., if applicable), and further processed by a receive processor 238 to obtain decoded data and control information sent by UE 104. Receive processor 238 may provide the decoded data to a data sink 239 and the decoded control information to controller (e.g., processor) 240. Base station 102 may include communication unit 244 and communicate to a network controller 231 via communication unit 244. Network controller 231 may include communication unit 294, controller/processor 290, and memory 292.

In some aspects, one or more components of UE 104 may be included in a housing. Controller 240 of base station 102, controller/processor 280 of UE 104, and/or any other component(s) of FIG. 2 may perform one or more techniques associated with implicit UCI beta value determination for NR.

Memories 242 and 282 may store data and program codes for the base station 102 and the UE 104, respectively. A scheduler 246 may schedule UEs for data transmission on the downlink, uplink, and/or sidelink.

In some aspects, deployment of communication systems, such as 5G new radio (NR) systems, may be arranged in multiple manners with various components or constituent parts. In a 5G NR system, or network, a network node, a network entity, a mobility element of a network, a radio access network (RAN) node, a core network node, a network element, or a network equipment, such as a base station (BS), or one or more units (or one or more components) performing base station functionality, may be implemented in an aggregated or disaggregated architecture. For example, a BS (e.g., such as a Node B (NB), evolved NB (eNB), NR BS, 5G NB, access point (AP), a transmit receive point (TRP), or a cell, etc.) may be implemented as an aggregated base station (e.g., also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (e.g., such as one or more central or centralized units (CUs), one or more distributed units (DUs), or one or more radio units (RUs)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU and RU also can be implemented as virtual units, i.e., a virtual central unit (VCU), a virtual distributed unit (VDU), or a virtual radio unit (VRU).

Base station-type operation or network design may consider aggregation characteristics of base station functionality. For example, disaggregated base stations may be utilized in an integrated access backhaul (IAB) network, an open radio access network (O-RAN (e.g., such as the network configuration sponsored by the O-RAN Alliance)), or a virtualized radio access network (e.g., vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

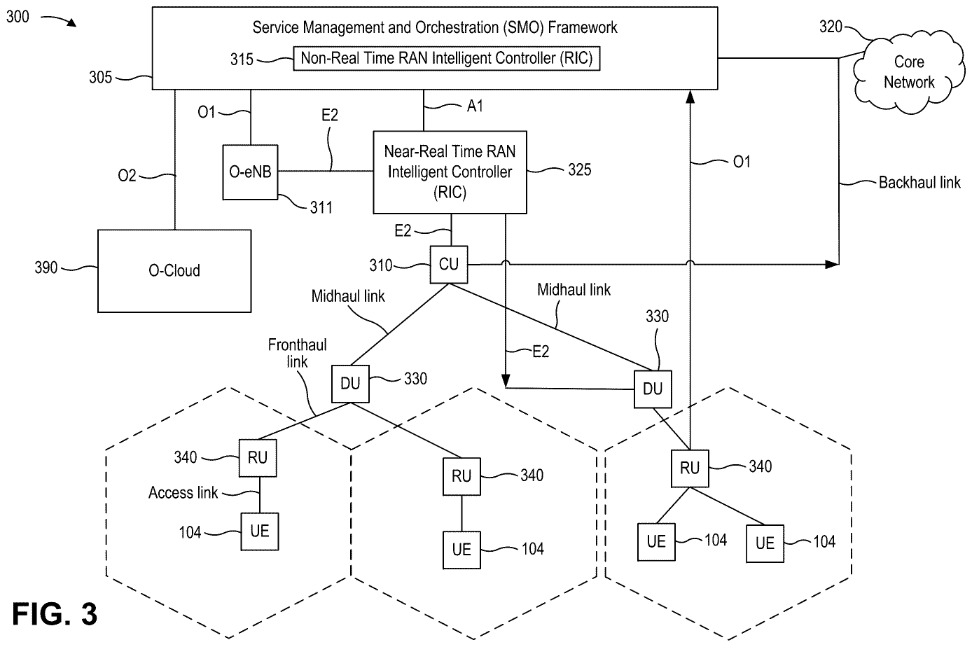

FIG. 3 is a diagram illustrating an example disaggregated base station 300 architecture. The disaggregated base station 300 architecture may include one or more central units (CUs) 310 that can communicate directly with a core network 320 via a backhaul link, or indirectly with the core network 320 through one or more disaggregated base station units (e.g., such as a Near-Real Time (Near-RT) RAN Intelligent Controller (RIC) 325 via an E2 link, or a Non-Real Time (Non-RT) RIC 315 associated with a Service Management and Orchestration (SMO) Framework 305, or both). A CU 310 may communicate with one or more distributed units (DUs) 330 via respective midhaul links, such as an F1 interface. The DUs 330 may communicate with one or more radio units (RUs) 340 via respective fronthaul links. The RUs 340 may communicate with respective UEs 104 via one or more radio frequency (RF) access links. In some implementations, the UE 104 may be simultaneously served by multiple RUs 340.

Each of the units (e.g., the CUs 310, the DUs 330, the RUs 340, as well as the Near-RT RICs 325, the Non-RT RICs 315, and the SMO Framework 305) illustrated in FIG. 3 and/or described herein may include one or more interfaces or be coupled to one or more interfaces configured to receive or transmit signals, data, or information (e.g., collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or transmit signals over a wired transmission medium to one or more of the other units. Additionally, the units can include a wireless interface, which may include a receiver, a transmitter or transceiver (e.g., such as a radio frequency (RF) transceiver), configured to receive or transmit signals, or both, over a wireless transmission medium to one or more of the other units.

In some aspects, the CU 310 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 310. The CU 310 may be configured to handle user plane functionality (e.g., Central Unit-User Plane (CU-UP)), control plane functionality (e.g., Central Unit-Control Plane (CU-CP)), or a combination thereof. In some implementations, the CU 310 can be logically split into one or more CU-UP units and one or more CU-CP units. The CU-UP unit can communicate bidirectionally with the CU-CP unit via an interface, such as the E1 interface when implemented in an O-RAN configuration. The CU 310 can be implemented to communicate with the DU 330, as necessary, for network control and signaling.

The DU 330 may correspond to a logical unit that includes one or more base station functions to control the operation of one or more RUs 340. In some aspects, the DU 330 may host one or more of a radio link control (RLC) layer, a medium access control (MAC) layer, and one or more high physical (PHY) layers (e.g., such as modules for forward error correction (FEC) encoding and decoding, scrambling, modulation and demodulation, or the like) depending on a functional split, such as those defined by the 3rd Generation Partnership Project (3GPP). In some aspects, the DU 330 may further host one or more low PHY layers. Each layer (or module) can be implemented with an interface configured to communicate signals with other layers (and modules) hosted by the DU 330, or with the control functions hosted by the CU 310.

Lower-layer functionality can be implemented by one or more RUs 340. In some deployments, an RU 340, controlled by a DU 330, may correspond to a logical node that hosts RF processing functions, or low-PHY layer functions (e.g., such as performing fast Fourier transform (FFT), inverse FFT (iFFT), digital beamforming, physical random-access channel (PRACH) extraction and filtering, or the like), or both, based on the functional split, such as a lower layer functional split. In such an architecture, the RU(s) 340 can be implemented to handle over the air (OTA) communication with one or more UEs 104. In some implementations, real-time and non-real-time aspects of control and user plane communication with the RU(s) 340 can be controlled by the corresponding DU 330. In some scenarios, this configuration can enable the DU(s) 330 and the CU 310 to be implemented in a cloud-based RAN architecture, such as a vRAN architecture.

The SMO Framework 305 may be configured to support RAN deployment and provisioning of non-virtualized and virtualized network elements. For non-virtualized network elements, the SMO Framework 305 may be configured to support the deployment of dedicated physical resources for RAN coverage requirements which may be managed via an operations and maintenance interface (e.g., such as an O1 interface). For virtualized network elements, the SMO Framework 305 may be configured to interact with a cloud computing platform (e.g., such as an open cloud (O-Cloud) 390) to perform network element life cycle management (e.g., such as to instantiate virtualized network elements) via a cloud computing platform interface (e.g., such as an O2 interface). Such virtualized network elements can include, but are not limited to, CUs 310, DUs 330, RUs 340, and Near-RT RICs 325. In some implementations, the SMO Framework 305 can communicate with a hardware aspect of a 4G RAN, such as an open eNB (O-eNB) 311, via an O1 interface. Additionally, in some implementations, the SMO Framework 305 can communicate directly with one or more RUs 340 via an O1 interface. The SMO Framework 305 also may include a Non-RT RIC 315 configured to support functionality of the SMO Framework 305.

The Non-RT RIC 315 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 325. The Non-RT RIC 315 may be coupled to or communicate with (e.g., such as via an A1 interface) the Near-RT RIC 325. The Near-RT RIC 325 may be configured to include a logical function that enables near-real-time control and optimization of RAN elements and resources via data collection and actions over an interface (e.g., such as via an E2 interface) connecting one or more CUs 310, one or more DUs 330, or both, as well as an O-eNB, with the Near-RT RIC 325.

In some implementations, to generate AI/ML models to be deployed in the Near-RT RIC 325, the Non-RT RIC 315 may receive parameters or external enrichment information from external servers. Such information may be utilized by the Near-RT RIC 325 and may be received at the SMO Framework 305 or the Non-RT RIC 315 from non-network data sources or from network functions. In some examples, the Non-RT RIC 315 or the Near-RT RIC 325 may be configured to tune RAN behavior or performance. For example, the Non-RT RIC 315 may monitor long-term trends and patterns for performance and employ AI/ML models to perform corrective actions through the SMO Framework 305 (e.g., such as reconfiguration via O1) or via creation of RAN management policies (e.g., such as A1 policies).

FIG. 4 illustrates an example of a processing system 470 of a wireless device 407. In some examples, the processing system 470 may also be referred to as a computing system. The processing system 470 may include and/or implement one or more components that are the same as or similar to respective components included in and/or implemented by the processing system 802 of FIG. 8 (e.g., and the processing system 802 of FIG. 8 may include and/or implement one or more components that are the same as or similar to respective components included in and/or implemented by the processing system 470 of FIG. 4). In some cases, the wireless device 407 may also be referred to as a user computing device. The wireless device 407 may include a client device such as a UE (e.g., UE 104, UE 152, UE 190) or other type of device (e.g., a station (STA) configured to communication using a Wi-Fi interface) that may be used by an end-user. In some cases, the processing system 470 of the wireless device 407 can be implemented by one or more of the UEs 104 of FIG. 1. For example, the wireless device 407 may include a mobile phone, router, tablet computer, laptop computer, tracking device, wearable device (e.g., a smart watch, glasses, an extended reality (XR) device such as a virtual reality (VR), augmented reality (AR), or mixed reality (MR) device, etc.), Internet of Things (IoT) device, a vehicle, an aircraft, and/or another device that is configured to communicate over a wireless communications network.

The processing system 470 includes software and hardware components that may be electrically or communicatively coupled via a bus 489 (e.g., or may otherwise be in communication, as appropriate). The processing system 470 may generally be a system including one or more components that may perform one or more functions, such as any function or combination of functions described herein. For example, one or more components may receive input information (e.g., any information that is an input, such as a signal, any digital information, or any other information), one or more components may process the input information to generate output information (e.g., any information that is an output, such as a signal or any other information), one or more components may perform any function as described herein, or any combination thereof. For example, the processing system 470 includes one or more processors 484. The one or more processors 484 may include one or more CPUs, ASICs, FPGAs, APs, GPUs, VPUs, NSPs, microcontrollers, dedicated hardware, any combination thereof, and/or other processing device or system. The bus 489 may be used by the one or more processors 484 to communicate between cores and/or with the one or more memory devices 486.

The processing system 470 may also include one or more memory devices 486, one or more digital signal processors (DSPs) 482, one or more SIMs 474, one or more modems 476, one or more wireless transceivers 478, an antenna 487, one or more input devices 472 (e.g., a camera, a mouse, a keyboard, a touch sensitive screen, a touch pad, a keypad, a microphone, and/or the like), and one or more output devices 480 (e.g., a display, a speaker, a printer, and/or the like).

In some aspects, processing system 470 may include one or more radio frequency (RF) interfaces configured to transmit and/or receive RF signals. In some examples, an RF interface may include components such as modem(s) 476, wireless transceiver(s) 478, and/or antennas 487. The one or more wireless transceivers 478 may transmit and receive wireless signals (e.g., signal 488) via antenna 487 from one or more other devices, such as other wireless devices, network devices (e.g., base stations such as eNBs and/or gNBs, Wi-Fi access points (APs) such as routers, range extenders or the like, etc.), cloud networks, and/or the like. In some examples, the processing system 470 may include multiple antennas or an antenna array that may facilitate simultaneous transmit and receive functionality. Antenna 487 may be an omnidirectional antenna such that radio frequency (RF) signals may be received from and transmitted in all directions. The wireless signal 488 may be transmitted via a wireless network. The wireless network may be any wireless network, such as a cellular or telecommunications network (e.g., 3G, 4G, 5G, etc.), wireless local area network (e.g., a Wi-Fi network), a Bluetooth™ network, and/or other network.

In some examples, the wireless signal 488 may be transmitted directly to other wireless devices using sidelink communications (e.g., using a PC5 interface, using a DSRC interface, etc.). Wireless transceivers 478 may be configured to transmit RF signals for performing sidelink communications via antenna 487 in accordance with one or more transmit power parameters that may be associated with one or more regulation modes. Wireless transceivers 478 may also be configured to receive sidelink communication signals having different signal parameters from other wireless devices.

In some examples, the one or more wireless transceivers 478 may include an RF front end including one or more components, such as an amplifier, a mixer (e.g., also referred to as a signal multiplier) for signal down conversion, a frequency synthesizer (e.g., also referred to as an oscillator) that provides signals to the mixer, a baseband filter, an analog-to-digital converter (ADC), one or more power amplifiers, among other components. The RF front-end may generally handle selection and conversion of the wireless signals 488 into a baseband or intermediate frequency and may convert the RF signals to the digital domain.

In some cases, the processing system 470 may include a coding-decoding device (or CODEC) configured to encode and/or decode data transmitted and/or received using the one or more wireless transceivers 478. In some cases, the processing system 470 may include an encryption-decryption device or component configured to encrypt and/or decrypt data (e.g., according to the AES and/or DES standard) transmitted and/or received by the one or more wireless transceivers 478.

The one or more SIMs 474 may each securely store an international mobile subscriber identity (IMSI) number and related key assigned to the user of the wireless device 407. The IMSI and key may be used to identify and authenticate the subscriber when accessing a network provided by a network service provider or operator associated with the one or more SIMs 474. The one or more modems 476 may modulate one or more signals to encode information for transmission using the one or more wireless transceivers 478. The one or more modems 476 may also demodulate signals received by the one or more wireless transceivers 478 in order to decode the transmitted information. In some examples, the one or more modems 476 may include a Wi-Fi modem, a 4G (or LTE) modem, a 5G (or NR) modem, and/or other types of modems. The one or more modems 476 and the one or more wireless transceivers 478 may be used for communicating data for the one or more SIMs 474.

The processing system 470 may also include (and/or be in communication with) one or more non-transitory machine-readable storage media or storage devices (e.g., one or more memory devices 486), which may include, without limitation, local and/or network accessible storage, a disk drive, a drive array, an optical storage device, a solid-state storage device such as a RAM and/or a ROM, which may be programmable, flash-updateable, and/or the like. Such storage devices may be configured to implement any appropriate data storage, including without limitation, various file systems, database structures, and/or the like.

In various aspects, functions may be stored as one or more computer-program products (e.g., instructions or code) in memory device(s) 486 and executed by the one or more processor(s) 484 and/or the one or more DSPs 482. The processing system 470 may also include software elements (e.g., located within the one or more memory devices 486), including, for example, an operating system, device drivers, executable libraries, and/or other code, such as one or more application programs, which may comprise computer programs implementing the functions provided by various aspects, and/or may be designed to implement methods and/or configure systems, as described herein.

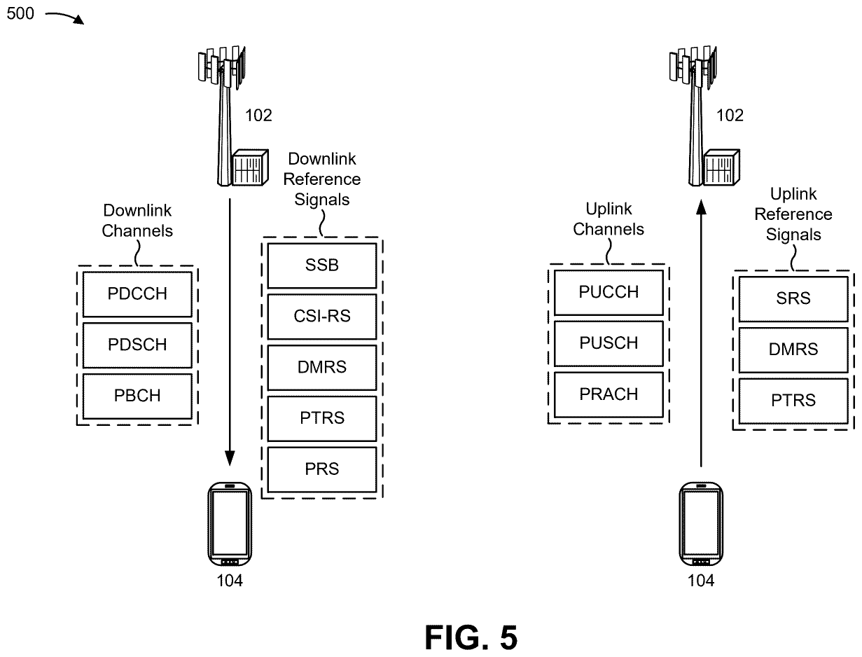

FIG. 5 is a diagram illustrating an example 500 of physical channels and reference signals in a wireless network. In some examples, one or more downlink channels and one or more downlink reference signals may carry information from a base station 102 to a UE 104. One or more uplink channels and one or more uplink reference signals may carry information from UE 104 to base station 102.

In some aspects, a downlink channel may include one or more of a physical downlink control channel (PDCCH) that carries downlink control information (DCI), a physical downlink shared channel (PDSCH) that carries downlink data, and/or a physical broadcast channel (PBCH) that carries system information, among other examples. In some aspects, PDSCH communications may be scheduled by PDCCH communications.

In some examples, an uplink channel may include one or more of a physical uplink control channel (PUCCH) that carries uplink control information (UCI), a physical uplink shared channel (PUSCH) that carries uplink data, and/or a physical random access channel (PRACH) used for initial network access, among other examples. In some aspects, UE 104 may transmit acknowledgement (ACK) or negative acknowledgement (NACK) feedback (e.g., ACK/NACK feedback or ACK/NACK information) in UCI on the PUCCH and/or the PUSCH.

In some cases, a downlink reference signal may include one or more of a synchronization signal block (SSB), a channel state information (CSI) reference signal (CSI-RS), a demodulation reference signal (DMRS), a positioning reference signal (PRS), and/or a phase tracking reference signal (PTRS), among other examples. In some examples, an uplink reference signal may include one or more of a sounding reference signal (SRS), a DMRS, and/or a PTRS, among other examples.

An SSB may carry or include information used for initial network acquisition and synchronization. For example, an SSB can carry or include one or more of a primary synchronization signal (PSS), a secondary synchronization signal (SSS), a PBCH, and/or a PBCH DMRS. An SSB may also be referred to as a synchronization signal/PBCH (SS/PBCH) block. In some aspects, base station 102 may transmit multiple SSBs on multiple corresponding beams, and the SSBs may be used for beam selection.

A CSI-RS may carry information used for downlink channel estimation (e.g., downlink CSI acquisition), which may be used for scheduling, link adaptation, or beam management, among other examples. For example, base station 102 can configure a set of CSI-RSs for UE 104, and UE 104 can measure the configured set of CSI-RSs. Based on the CSI-RS measurements, UE 104 can perform channel estimation and report channel estimation parameters to base station 102 (e.g., in a CSI report). For example, the channel estimation parameters can include one or more of a channel quality indicator (CQI), a precoding matrix indicator (PMI), a CSI-RS resource indicator (CRI), a layer indicator (LI), a rank indicator (RI), and/or a reference signal received power (RSRP), among other examples.

In some examples, base station 102 can use the CSI report to select transmission parameters for downlink communications to UE 104. For example, base station 102 can use the CSI report to select transmission parameters that include one or more of a quantity of transmission layers (e.g., a rank), a precoding matrix (e.g., a precoder), a modulation and coding scheme (MCS), and/or a refined downlink beam (e.g., using a beam refinement procedure or a beam management procedure), among other examples.

A DMRS may carry information used to estimate a radio channel for demodulation of an associated physical channel (e.g., PDCCH, PDSCH, PBCH, PUCCH, or PUSCH). The design and mapping of a DMRS may be specific to a physical channel for which the DMRS is used for estimation. DMRSs are UE-specific, can be beamformed, can be confined in a scheduled resource (e.g., rather than transmitted on a wideband), and can be transmitted only when necessary. As shown, DMRSs are used for both downlink communications and uplink communications.

A PTRS can carry information used to compensate for oscillator phase noise. In some cases, oscillator phase noise may increase as an oscillator carrier frequency increases. In some examples, a PTRS can be utilized at high carrier frequencies (e.g., such as millimeter wave frequencies) to mitigate oscillator phase noise. The PTRS may be used to track the phase of the local oscillator and to enable suppression of phase noise and common phase error (CPE). As illustrated in FIG. 5, in some examples one or more PTRSs can be used for both downlink communications (e.g., on the PDSCH) and uplink communications (e.g., on the PUSCH).

A PRS may carry information associated with timing or ranging measurements of UE 104. For example, UE 104 may utilize one or more signals (e.g., PRSs) transmitted by base station 102 to improve an observed time difference of arrival (OTDOA) positioning performance. In some examples, a PRS may be a pseudo-random Quadrature Phase Shift Keying (QPSK) sequence mapped in diagonal patterns with shifts in frequency and time to avoid collision with cell-specific reference signals and control channels (e.g., a PDCCH). A PRS can be designed to improve detectability by UE 104, which may need to detect downlink signals from multiple neighboring base stations in order to perform OTDOA-based positioning. Accordingly, UE 104 may receive a PRS from multiple cells (e.g., a reference cell and one or more neighbor cells), and may report a reference signal time difference (RSTD) based on OTDOA measurements associated with the PRSs received from the multiple cells. In some aspects, base station 102 can calculate a position of UE 104 based on the RSTD measurements reported by UE 104.

In some examples, an SRS can carry information used for uplink channel estimation, which may be used for scheduling, link adaptation, precoder selection, and/or beam management, among other examples. Base station 102 can configure one or more SRS resource sets for UE 104, and UE 104 can transmit SRSs on the configured SRS resource sets. An SRS resource set may have a configured usage, such as uplink CSI acquisition, downlink CSI acquisition for reciprocity-based operations, uplink beam management, among other examples. Base station 102 may measure the SRSs, may perform channel estimation based on the measurements, and/or may use the SRS measurements to configure communications with UE 104.

TRS is another example of a downlink reference signal, and may carry information from the base station 102 to the UE 104 of FIG. 5. As noted above, TRS can be used for time tracking, frequency tracking, or both. For example, a UE can use one or TRS transmissions from a base station for tracking frequency and timing offsets. In some cases, UEs may be configured to use the TRS to perform phase noise compensation in higher-frequency bands (e.g., mmWave, etc.), to perform time synchronization for alignment with the transmission timing of a base station (e.g., gNB, etc.), associated with the TRS, to perform frequency synchronization corresponding to compensation for a carrier frequency offset, channel estimation for relatively high Doppler scenarios, etc. TRS transmission may be performed periodically and/or aperiodically in the downlink. TRS transmissions can be performed independently from various physical downlink shared channel (PDSCH) transmission, and can be used for tracking across multiple slots. In some examples, a 5G NR system can use TRS for time-frequency tracking for synchronization. In some cases, a 5G NR system may use TRS for power delay profile (PDP) tracking associated with or corresponding to channel estimation.

For example, in 5G NR, power delay profile (PDP) estimation can be performed based on synchronization signal blocks (SSBs) and/or TRS. The PDP estimation can be used for estimating time-domain characteristics of a multipath wireless channel, for example based on measurements of received power over different delay taps. In some aspects, the transmission (and corresponding reception) of a TRS at a configured interval can be used by a UE to measure the time delays of different multipath components. For example, based on correlating received TRS signals with the respective expected sequence information for the received TRS signals, the UE can determine the time-of-arrival for each multipath component, and can form an estimate of the PDP from the multi-path component time of arrival information. In some cases, a UE can use periodic and/or aperiodic TRS receptions over time to estimate the PDP, based on using the TRS receptions to determine a channel response that can be used to determine the channel delay spread and/or coherence time for the PDP estimation.

In some cases, PDP estimation based on SSB and/or TRS may be inaccurate for a control or data channel that is not quasi-collocated (QCL'ed) with the SSB and/or TRS. For example, a channel that is not QCL'ed with the SSB and/or TRS can be referred to as a non-QCL'ed channel, where the non-QCL'ed channel does not have the same (e.g., highly correlated) channel characteristics as the SSB and/or TRS. In another example, the SSB and/or TRS-based PDP estimation can be inaccurate for a control/data channel that uses DMRS precoding. In some cases, the SSB and/or TRS-based PDP estimation may be inaccurate for a control/data channel having a frequency domain resource allocation (FDRA) that differs from the FDRA associated with the SSB and/or TRS by more than a threshold amount.

In some cases, PDP tracking and/or PDP estimation performed based on TRS may be implemented for channels without a precoder (e.g., non-precoded channels, etc.). PDP tracking and/or PDP estimation performed based on TRS may be performed based on a configuration where the TRS is transmitted from a single antenna element (e.g. antenna array, antenna port, etc.) of a base station or other network entity (e.g., also referred to as a single-port TRS and/or single port TRS transmission, etc.). For example, 5G NR systems may be configured to use single-port TRS where the TRS is transmitted by a single antenna port (e.g., single antenna element) of a network entity (e.g., base station, gNB, etc.). Based on using the single-port TRS configuration, TRS transmission in 5G NR systems may be performed without pre-coding on the data channel, in uplink and/or downlink.

In one illustrative example, the systems and techniques described herein can be used to provide multi-port TRS configurations for TRS transmission on a multiple input, multiple output (MIMO) channel and/or other precoded channel associated with multiple antenna ports and/or multiple transmit antennas. In some cases, the precoded channel may be a clustered MIMO channel, for example represented by the matrix H_{N}_{_{R}}_{×N}_{_{T}} which represents a physical, over-the-air (OTA) clustered MIMO channel with a quantity N_{R} of receive antennas, and a quantity N_{T} of transmit antennas (e.g., also referred to as transmit antenna ports, Tx ports, etc.).

In some cases, using one or more precoders and/or precoding matrices to process a signal prior to transmission can correspond to changing the PDP of the effective over the air channel. For example, one or more precoders can be used for the clustered MIMO channel H_{N}_{_{R}}_{×N}_{_{T}} to apply a matrix of various precoding weights (e.g., precoding weights included in a precoding matrix associated with the precoder) at different frequencies for the subcarriers of the clustered MIMO channel. In one illustrative example, an L-layer linear precoder P_{N}_{_{T}}_{×L} can be applied for the N_{T} transmit antenna ports of the clustered MIMO channel H_{N}_{_{R}}_{×N}_{_{T}}, and may perform precoding that changes the PDP of the effective channel given by H_{N}_{_{R}}_{×N}_{_{T}}×P_{N}_{_{T}}_{×L}.

Frequency domain (FD) correlation can be determined for a precoded channel, corresponding to the correlation of channel responses across different frequency subcarriers when precoding is applied at the transmitter (e.g., precoding associated with the N_{T} transmit antenna ports, etc.). FD correlation information can be indicative of and/or based on frequency selectivity of signals on the clustered MIMO channel, corresponding to changes in the channel response across different subcarriers from multipath fading. In some aspects, the FD correlation can be determined as a measure of similarity of the channel responses between adjacent or non-adjacent frequency subcarriers of the clustered MIMO channel. The different precoding weights included in the pre-coding matrix for the L-layer linear precoder P_{N}_{_{T}}_{×L} can affect (e.g., change) the level of correlation between subcarriers.

For example, precoding can be performed to provide structured correlation across frequencies of the subcarriers of the clustered MIMO channel. Applying the same precoding matrix across all of the subcarriers can be associated with relatively high FD correlation between subcarriers. In some cases, frequency-selective precoding may be performed, where different frequency bins (e.g., different frequency subcarriers) are processed according to different precoding weights of a frequency-selective precoding matrix. Frequency-selective precoding may correspond to relatively lower FD correlation. In some cases, the FD correlation can be based at least in part on channel conditions for the clustered MIMO channel. For example, a relatively flat frequency channel may be associated with relatively higher FD correlation, based on the subcarriers experiencing approximately the same fading on the frequency-flat channel. In a frequency selective channel, different subcarriers can be associated with different fading conditions, which reduces FD correlation. In some aspects, higher FD correlation corresponds to lower diversity gains from frequency-selective scheduling, while lower FD correlation corresponds to increased frequency diversity (e.g., which may be associated with or used to provide improved MIMO performance). In some cases, higher FD correlation can be used for CSI feedback compression, as the higher FD correlation or similarity across the different subcarriers can be used to reduce the number and/or frequency in time of the CSI reports transmitted relating to the channel. In some examples, lower FD correlation may be associated with more detailed and/or more frequent in time transmission of CSI reports, based on the relative dissimilarity of channel conditions on the different subcarriers of the clustered MIMO channel, etc.

In some examples of a clustered MIMO channel with precoding applied (e.g., such as the effective channel H_{N}_{_{R}}_{×N}_{_{T}}×P_{N}_{_{T}}_{×L}), FD correlation can be determined according to various configurations. For example, in some cases FD correlation can be determined for a precoded channel based on calculating a respective FD correlation between each unique pair of transmit antenna port (e.g., Tx port) and receive antenna (e.g., Rx antenna). For the clustered MIMO channel H_{N}_{_{R}}_{×N}_{_{T}}, the number of respective FD correlations calculated for the precoded MIMO channel can be equal to the number of transmit antenna ports (e.g., N_{T}) multiplied by the number of receive antennas (e.g., N_{R}), given as N_{T}·N_{R}.

In some cases, the FD correlation may be determined for each Tx port and Rx antenna (e.g., each pair of the N_{T}·N_{R} FD correlation pairs) over a subset or configured portion of the system bandwidth, and/or may be determined for each Tx port and Rx antenna over a wide band comprising the system bandwidth. For example, the FD correlation can be determined for each Tx port and Rx antenna pair (e.g., of the N_{T}·N_{R} pairs) over a narrow band subset comprising a configured quantity of resource blocks (RBs) (e.g., four RBs, 6 RBs, 8 RBs, etc.). In some example, FD correlation can be determined as an average FD correlation for each transmit antenna port of the set of transmit antenna ports N_{T}. For example, for a set of three transmit antennas N_{T}={N₁, N₂, N₃}, a first averaged FD correlation can be determined by averaging the pair-wise FD correlations between N₁ and each respective Rx antenna. A second averaged FD correlation can be determined by averaging the pair-wise FD correlations between N₂ and each respective Rx antenna, and a third averaged FD correlation can be determined by averaging the pair-wise FD correlations between N₃ and each respective Rx antenna.

In some aspects, FD correlations per Tx antenna port (e.g., FD correlation between the Tx antenna port and a particular Rx antenna of the set of Rx antennas N_{R}, or the averaged FD correlation between the Tx antenna port and each Rx antenna of the set of Rx antennas N_{R}) can have an eigenmode dependency, where the strongest FD correlation corresponds to the strongest eigenmode, and where the weakest eigenmode has the weakest FD correlation. For example, the effective precoded channel corresponding to a strongest eigenmode can have the strongest FD correlation. The effective precoded channel with the strongest FD correlation can be the effective precoded channel with the shortest time delay spread (e.g., shortest span of the PDP), based on an inverse relationship between the FD correlation and the time delay spread/PDP span.

In another example, the effective precoded channel corresponding to a weakest eigenmode can have the weakest FD correlation, and the longest time delay spread (e.g., longest PDP span). In some examples, when TRS is transmitted from N_{T} antenna elements with equal weight 1\sqrt{N_{T}}, the corresponding FD correlation can match the strongest eigenmode. In examples where TRS is transmitted from a single antenna element without beamforming, the average delay spread may be determined based on (e.g., derived from, etc.) the FD correlation, and can be used as a lower bound for the weakest eigenmode. In some cases, the PDP or frequency domain correlation for a precoded channel (e.g., including a clustered MIMO channel, etc.) can be estimated from TRS, and the FD correlation may be a function of the delay spread of the PDP. For example, a PDP with a large delay spread may be associated with the FD correlation decreasing with increased SCS, and a PDP with a narrower delay spread may be associated with a high FD correlation (e.g., a PDP with narrow delay spread can indicate the channel remains highly correlated in the frequency domain).

In one illustrative example, the systems and techniques can be used for PDP estimation for precoded channels by a UE, where the PDP estimation for a precoded channel is performed based on a multi-port TRS transmission received and/or measured by the UE. In some aspects, the multi-port TRS transmission can be used by the UE to determine channel information corresponding to the precoded channel, where the channel information corresponding to the precoded channel can be determined before the UE performs transmission or reception on the precoded channel. For example, the UE can use the multi-port TRS to determine information corresponding to the effective channel for the precoded channel, based on FD correlation and/or PDP information of the multi-port TRS. For example, based on the strongest FD correlation corresponding to the strongest eigenmode effective channel, the UE may use the multi-port TRS to determine the strongest eigenmode effective channel without or before transmitting and/or receiving over the effective channel (e.g., precoded channel, clustered MIMO channel, etc.).

In some aspects, FD correlations may be estimated or determined in the frequency domain, and the PDP information may be determined in the time domain. A stronger FD correlation can have a sharper peak in the frequency domain, which may correspond to a narrower (e.g., shorter) PDP window. In one illustrative example, the systems and techniques can use multi-port TRS the obtain information for the PDP of a fading channel with or without precoding. In some examples, the PDP information determined using the multi-port TRS can be combined with channel estimation, interference cancellation, and/or tracking loops to improve the performance of single user MIMO (SU-MIMO) communications and/or multiple user MIMO (MU-MIMO) communications by the UE.

In some aspects, a multi-port TRS configuration can be implemented using antenna port virtualization, where a network entity (e.g., base station, gNB, etc.) configured N>1 Tx antenna ports for a TRS group. For example, the network entity can configure a TRS group comprising the N>1 Tx antenna ports. The configured TRS group can be used for transmission of the multi-port TRS, based on transmitting the TRS using the N>1 Tx antenna ports included in the TRS group. In some cases, the antenna port virtualization and/or the TRS group of the multiple, N Tx antennas can be implemented to reduce the complexity of precoder selection and PDP estimation for control and/or data channels. In some aspects, the antenna port virtualization and/or use of the TRS group can improve the reliability of the precoder selection and PDP estimation for control and/or data channels.

The multiple Tx antenna ports configured for a TRS group can be used as different respective Tx antenna ports for TRS transmission, where each respective Tx antenna port for the TRS transmission is associated with a different FD correlation. In some aspects, the TRS transmission may be configured for different combinations or weights of Tx ports from the N port TRS group to provide different PDP estimation profiles for a UE receiving the TRS transmission. Based on the different TRS configurations from an N port TRS group, the UE can use the different PDP estimation profiles from the N port TRS transmission to obtain information of a precoded data channel, before transmission and reception are performed on the precoded data channel. For example, TRS can be transmitted by a network entity (e.g., base station, gNB, etc.) independent of a data channel.

In some cases, a network entity transmits TRS as a standalone signal that is independent of data scheduled for the UE. For example, the network may not have any data to schedule for the UE, but may transmit a TRS for the UE independent from the data channel on which no data has been scheduled for the UE. Based on the TRS, the UE can determine channel estimates or other channel information for the data channel, without receiving data on the data channel to determine the channel estimate or other channel information directly. Using a multi-port TRS and FD correlation information associated with the PDP of a precoded channel, a UE can be configured to determine channel estimates or other channel estimation for the precoded data/control channel, without receiving data on the precoded data/control channel.

For example, a UE can use the multi-port TRS to determine information indicative of the lower bound and/or upper bound of the PDP of a precoded channel that is scheduled after the multi-port TRS. As noted above, the strongest eigenmode and strongest FD correlation can be associated with the shortest (e.g., narrowest) PDP time window, and the weakest eigenmode and weakest FD correlation can be associated with the longest (e.g., widest) PDP time window. In one illustrative example, the lower bound and/or upper bound information for the PDP time window or delay spread can be used to improve the accuracy of the channel estimation performed by the UE for a precoded data channel, prior to the UE receiving on the precoded data channel. An improved accuracy channel estimation for the precoded data channel can be used to improve the accuracy and/or performance of subsequent demodulation and decoding operations performed by the UE for signals received on the precoded data channel.

In some examples, the multi-port TRS (e.g., N-port TRS) can be mapped to OFDM symbols that are consecutive or distributed in time. Based on the consecutive mapping or distributed mapping, a UE can measure the multi-port TRS transmission from the corresponding OFDM symbols. Based on FD correlation being the inverse discrete Fourier transform (IDFT) of the PDP, in some examples a UE can be configured to report supplementary CSI feedback indicative of the FD correlation and/or the PDP determined from the multi-port TRS. For example, the UE can measure a multi-port TRS and determine the FD correlation and/or PDP for the multi-port TRS. In some cases, the UE can generate and transmit, to a network entity (e.g., base station, gNB, etc.) supplementary CSI feedback indicative of the FD correlation. In some aspects, the UE can generate and transmit supplementary CSI feedback indicative of a PDP estimation determined from the TRS waveform received in the time domain. Reporting the supplemental CSI feedback indicative of the time domain PDP estimation can reduce the overhead for the UE, as the time domain PDP estimation can be determined earlier in the receive processing chain of the UE than the frequency domain FD correlation. In some cases, the time domain PDP estimate can be used instead of the FD correlation, and the FD correlation can be obtained as the IDFT of the time domain PDP estimate indicated in the supplemental CSI feedback from the UE.

For example, signal reception can be performed by the one or more Rx antennas of a UE in the time domain. In some aspects, a UE may receive a TRS (e.g., single port TRS, multi-port TRS, N-port TRS, etc.) as a received time domain waveform. For various frequency domain processing operations implemented by a UE, a fast Fourier transform (FFT) is first applied to the received time domain waveforms, to convert to the frequency domain. Frequency domain processing operations of the UE are performed after the FFT of the received time domain waveform. For example, frequency domain processing of a TRS (e.g., such as determining the FD correlation of the TRS) can be performed based on a UE receiving a TRS waveform in the time domain, performing an FFT of the received TRS waveform to convert from the time domain to the frequency domain, and subsequently calculating the FD correlation and/or performing other frequency domain processing after the FFT.

In one illustrative example, a UE can be configured to receive a multi-port TRS and perform PDP estimation directly in the time domain, using the received time domain waveform of the multi-port TRS. The PDP estimation in the time domain may be implemented by the UE before the FFT to convert the multi-port TRS to the frequency domain, whereupon the UE can calculate the FD correlation for the multi-port TRS. In some aspects, configuring the UE to determine a time domain PDP estimation can be used to obtain, by the UE, information of the pre-coded data/control channel without (or before) performing an FFT and subsequent frequency domain processing for the received multi-port TRS waveform. In some cases, the UE can use the time domain PDP estimation from the multi-port TRS waveform to determine channel information for decoding and demodulating the precoded data channel, without or before the UE performing an FFT and/or frequency domain processing for the multi-port TRS.

In another illustrative example, the UE can determine an additional QCL type based on FD correlation. For example, a QCL type based on FD correlation can be implemented between TRS (e.g., a multi-port TRS) and precoded DMRS. In some cases, the QCL type based on the FD correlation is configured for the TRS and precoded DMRS of the precoded data or control channel(s) associated with the UE. A QCL type can correspond to quasi co-location (QCL) over two different types of reference signal (RS). The QCL type based on FD correlation can correspond to quasi co-location over a first type of reference signal (e.g., TRS and/or multi-port TRS, etc.) and a second type of reference signal (e.g., precoded DMRS). For example, the FD correlation-based QCL type configured for TRS and precoded DMRS can be used based on the TRS and precoded DMRS sharing a common FD correlation property. In some examples, one or more additional QCL relationships can be configured by a network entity (e.g., base station, gNB, etc.) between each of the N-port TRS (e.g., each of the multi-port TRS) and the associated DMRS port (or DMRS port group) of precoded control/data channels (e.g., as precoding may be applied to both control and data channels).

Multi-modal TRS configurations may be supported in 6G (and beyond) wireless network standards and/or implementations, where a multi-modal TRS configuration can correspond to the use of a single TRS port to transmit TRS and/or the use of multiple TRS ports for transmitting TRS. A TRS port may be a particular antenna port (e.g., of a network entity) over which TRS is transmitted. The number of TRS ports may be the same as the number of spatial layers or beams that are used for the multi-port TRS. When TRS is QCL'ed with data and control channels, a UE or other network device can use a TRS reception to perform channel estimation corresponding to the QCL'ed data and/or control channels associated with the TRS received and measured by the UE.

In some examples, the systems and techniques can be used to provide resource mapping configurations for a multi-port TRS group. For example, a multi-modal TRS configuration with multiple TRS ports may correspond to a network entity performing TRS transmission where each respective TRS transmission comprises multiple TRS symbols in the time domain (e.g., a TRS group). The multi-modal TRS configuration can be indicative of the number of TRS ports, N, for the TRS group corresponding to the multi-modal TRS configuration. For example, a multi-modal TRS configuration may be indicative of a TRS group with N=2 TRS ports, a TRS group with N=3 TRS ports, a TRS group with N=4 TRS ports, . . . , etc. The multi-port TRS group may also be referred to as an N-port TRS group with N>1. In some aspects, the multi-port TRS group(s) may be implemented in addition to the single-port TRS that is transmitted pair-wise in a single slot or across two adjacent slots. In one illustrative example, a multi-port (e.g., N-port) TRS group can be configured by a network entity (e.g., base station, gNB, etc.) in an RRC message, a system information (SI), etc. In some aspects, the multi-port TRS group can be configured via RRC and/or SI, and may later be activated (e.g., by the network entity) using a MAC-CE or DCI.

In some aspects, a UE can be configured to transmit a request indicative of an on-demand configuration for a multi-port TRS group. For example, the UE can transmit to the network entity a request for on-demand configuration of a multi-port TRS group by the network entity, and for the UE. For example, a UE may be configured to transmit a request for on-demand configuration for a multi-port TRS group to assist the UE with tracking and/or channel estimation based on a corresponding multi-port TRS transmitted over the multi-port TRS group of the on-demand configuration request.

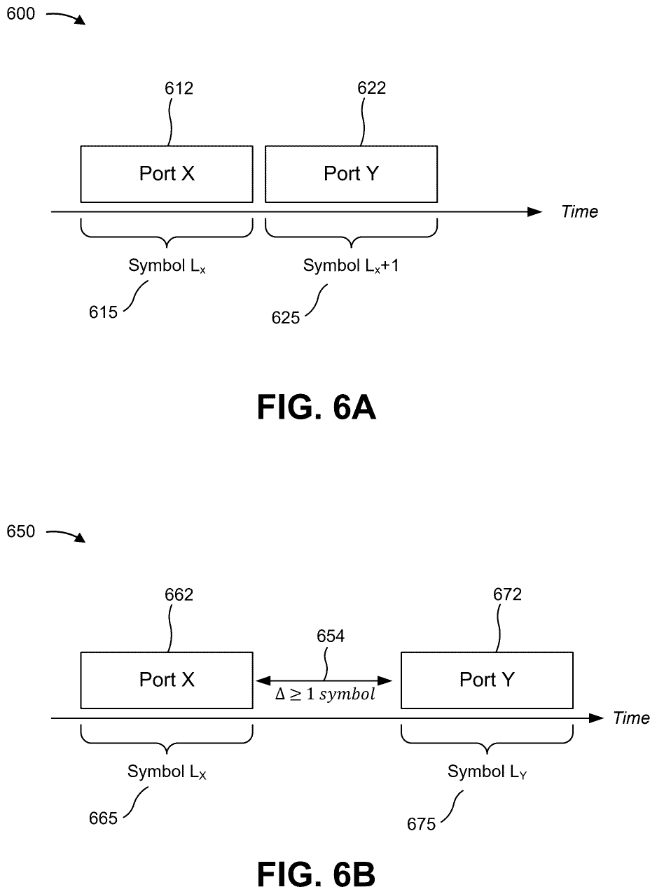

In some examples, the multi-port TRS in the same group can be time division multiplexed (TDM'ed) and mapped to OFDM symbols that are consecutive in the time domain, or can be TDM'ed and mapped to OFDM symbols that are distributed in the time domain. For example, FIG. 6A is a diagram illustrating an example of a multi-port TRS configuration 600 where the multi-port TRS is TDM'ed and mapped to OFDM symbols that are consecutive in the time domain. FIG. 6B is a diagram illustrating an example of a multi-port TRS configuration 650 where the multi-port TRS is TDM'ed and mapped to OFDM symbols that are distributed (e.g., non-consecutive) in the time domain. In some aspects, the example multi-port TRS configuration 600 of FIG. 6A and the multi-port TRS configuration 650 of FIG. 6B can correspond to an N-port TRS group, where N=2.

For example, the consecutive mapping multi-port TRS configuration 600 of FIG. 6A can correspond to a first TRS port 612 (e.g., “Port X”) of the 2-port TRS group being mapped to a first symbol L_{X} 615, and a second TRS port 622 (e.g., “Port Y”) of the 2-port TRS group being mapped to the next symbol L_{X}+1 (e.g., symbol 625). The symbols 615 and 625 can be consecutive symbols that are adjacent in time, without a gap of one or more additional symbols between the first symbol L_{X} 615 mapped to the first TRS port 612 and the second symbol L_{X}+1 625 mapped to the second TRS port 622.

The distributed mapping multi-port TRS configuration 650 of FIG. 6B can correspond to a first TRS port 662 (e.g., “Port X”) that may be the same as or similar to the first TRS port 612 of FIG. 6A, and a second TRS port 672 (e.g., Port Y”) that may be the same as or similar to the second TRS port 622 of FIG. 6A. The first TRS port 662 can be mapped to a first TRS symbol L_{X} 665, which may be the same as or similar to the first TRS symbol L_{X} 615 of FIG. 6A. In the distributed mapping configuration 650 of FIG. 6B, a gap 654 of length Δ≥1 symbol is included between the first TRS symbol 615 and the next (e.g., second) TRS symbol L_{Y} 675 that is mapped to the second TRS port 672. In the distributed configuration 650 of FIG. 6B, the second TRS symbol L_{Y} 675 is transmitted at a later time slot than the second TRS symbol L_{X}+1 625 of the consecutive configuration 600 of FIG. 6A.

In some aspects, one or more non-TRS symbols can be transmitted during or within the time gap 654 of the distributed mapping configuration 650. For example, TRS symbols are downlink symbols. In some cases, to transmit one or more uplink symbols between two TRS downlink symbols, the distributed mapping 650 of FIG. 6B can be configured, and the one or more uplink symbols can be transmitted during the time gap 654 between the first downlink TRS symbol 665 and the second downlink TRS symbol 675. In some examples, the distributed mapping configuration 650 can be used for non-consecutive transmission of the TRS symbols for a multi-port TRS group, based on different slot formats at the network entity, to enlarge the tracking range, etc. In some aspects, the multi-modal TRS configuration for implementing the multi-port TRS group can be signaled by the network entity to one or more UEs, and the multi-modal TRS configuration can include an indication of the type of symbol mapping used for the TRS symbols of the multi-port TRS group (e.g., an indication that consecutive mapping 600 is used, an indication that distributed mapping 650 is used, etc.).

In some cases, for a respective multi-port TRS group, the frequency density and/or bandwidth allocation of each TRS port can be jointly configured by the network entity. For example, a joint configuration may correspond to each TRS port of the N TRS ports included in an N-port TRS group using the same frequency density and bandwidth allocation, based on a common value configured for the frequency density in the joint configuration and a common value configured for the bandwidth allocation in the joint configuration.

In another example, for a respective multi-port TRS group, the frequency density and/or bandwidth allocation of each TRS port can be separately (e.g., individually) configured for one or more of the TRS ports. For example, a first subset of TRS ports of the N-port TRS group can be configured to use a first set of respective values for the frequency density and/or bandwidth allocation, a second subset of TRS ports of the N-port TRS group can be configured to use a second set of respective values for the frequency density and/or bandwidth allocation, etc. The first subset can include one TRS port of the TRS group or can include multiple TRS ports of the TRS group. The second subset can include one TRS port of the TRS group or can include multiple TRS ports of the TRS group, etc. In some aspects, the first and second sets of respective values for the first and second subsets of TRS ports of the TRS group can be indicated as separate configurations from the network entity. In some examples, the network entity can provide separate (e.g., individual) configurations for each respective TRS port of the set of multiple TRS ports included in a TRS group.

In one illustrative example, for a 2-port TRS group (e.g., a multi-port TRS group with N=2), a first TRS port X may be associated with stronger FD correlation and a second TRS port Y may be associated with a weaker FD correlation. Based on the FD correlation for the respective TRS ports of the TRS group, the network entity can provide joint or separate configuration information for the TRS group, where the configuration indicates that the first TRS port X with the stronger FD correlation is configured with a lower frequency density and/or wider bandwidth, while the second TRS port Y with weaker FD correlation is configured with a higher frequency density and/or narrower bandwidth, etc. The FD correlations used to determine the respective configuration(s) for different TRS ports of the TRS group may be known to the network entity, based at least in part on the precoder(s) and precoding matrices used by the network entity.

In some aspects, the systems and techniques can be used to provide CSI feedback for a multi-port TRS group. For example, the CSI feedback can be used to indicate the different observations at a UE of the different PDPs for different TRS port groups and configurations. In single-port TRS transmission, a UE may not transmit CSI feedback, as the single-port TRS transmission always uses the same antenna port and a feedback mechanism is not needed or utilized. In some cases, a CSI report associated with FD correlation and/or PDP estimation of a multi-port TRS group can be configured for transmission from a UE to a network entity.

In some aspects, to provide timely feedback to the network entity to perform precoder selection for use on the precoded data or control channel, the UE may be configured to generate and transmit the CSI feedback for the multi-port TRS group within a CSI report associated with a priority (e.g., a first priority value, a first priority level, a first priority, etc.) that is greater than or equal to the priority (e.g., a second priority value, a second priority level, a second priority, etc.) for a CSI report associated with precoding matrix indicator (PMI) information, rank indicator (RI) information, and/or channel quality indicator (CQI) information.

For example, the CSI report associated with the multi-port TRS group can be transmitted according to a first priority value that is greater than or equal to a second priority value associated with a CSI report for PMI, RI, and/or CQI information. In some aspects, the first priority value being greater than or equal to the second priority value can correspond to the UE transmitting the CSI report for the multi-port TRS group before the UE transmits (e.g., at a later time) a CSI report indicative of PMI, RI, and/or CQI information. In some aspects, configuring the priority for the FD correlation or PDP supplemental CSI report for the multi-port TRS group to be greater than or equal to the CSI report for PMI/RI/CQI can be used to cause the UE to transmit the supplemental CSI feedback for the FD correlation or PDP before the more detailed CSI reporting for PMI/RI/CQI.

In some cases, the systems and techniques can be configured to implement CSI report compression to reduce the quantity of CSI feedback from the UE to the network entity. In one illustrative example, a UE can be configured to provide a CSI report indicative of the quantized FD correlation of a TRS port over a reduced bandwidth W*, where the reduced bandwidth W* is less than the bandwidth of the multi-port TRS. In some aspects, the reduced bandwidth W* to be used for the quantized FD correlation reporting of the TRS port over the reduced bandwidth W* can be configured by the network entity. For example, the network entity can indicate to the UE (e.g., provide signaling or other information to the UE, etc.) indicative of the size of PRG for the reduced bandwidth W*. In some cases, the reduced bandwidth W* used for a quantized FD correlation report of a TRS port over the reduced bandwidth W* can be reported by the UE to the network entity, for example based on the UE including within a supplemental CSI report transmitted to the network entity an indication of the reduced bandwidth W* used by the UE to generate the supplemental CSI report. In some cases, the reduced bandwidth W* reported by the UE may be configured as α/T_{CP}, where T_{CP} is the cyclic prefix (CP) time duration and α22 0 is reported by the UE.

In another illustrative example, the UE can be configured to report the effective PDP window size derived from FD correlation of a TRS port included in a multi-port TRS group. For example, the magnitude for the first path and the last path within the PDP window can be greater than a threshold configured by the network.

In another illustrative example, the UE can be configured to report the percentage of FD correlation values that are above (e.g., greater than) a threshold ρ_{FC} for a TRS port on a reduced bandwidth W*. In some examples, the UE can be configured to report the percentage of multi-paths greater than a threshold ρ_{PDP} for a TRS port within the PDP derived from FD correlation. The thresholds ρ_{FC} and/or ρ_{PDP} can be configured threshold values indicated from the network entity to the UE. In some aspects, the threshold can be included in the multi-modal TRS configuration used to configure the multi-port TRS group for the UE.

In another illustrative example, the UE can be configured with an additional set of thresholds that are used to determine whether and how to provide the CSI feedback for a particular TRS port of the multiple TRS ports within the N-port TRS group. For example, if the percentage of FD correlation greater than the threshold ρ_{FC} (e.g., the threshold ρ_{FC} noted above) is itself lower than an additional threshold γ_{FC} for a particular TRS port, then based on a set of rules configured by the network entity, the UE may determine to waive the CSI feedback reporting for the particular TRS port. In some cases, the percentage of FD correlation greater than the threshold ρ_{FC} being lower than an additional threshold γ_{FC} for a particular TRS port can cause the UE to report CSI feedback indicative of an invalid configuration for the particular TRS port, and/or can cause the UE to transmit to the network entity a request for reconfiguration of the particular TRS port/resource.

In some cases, the network entity can configure the UE with an indication of one or more techniques to implement for the CSI report compression for reducing the CSI feedback quantity. In some examples, the UE can transmit to the network entity an indication of a preference for technique(s) to be used by the UE for CSI report compression to reduce the CSI feedback quantity. In some examples, the technique(s) used to be used by the UE for CSI report compression to reduce the CSI feedback quantity may be based at least in part on UE capability information for the UE.

In some aspects, the systems and techniques can be used to implement and/or configure the UE and network entity to perform multi-port TRS in correspondence with an additional QCL type based on FD correlation. For example, a QCL type based on FD correlation can be implemented between TRS (e.g., a multi-port TRS) and precoded DMRS. In some cases, the QCL type based on the FD correlation is configured for the TRS and precoded DMRS of the precoded data or control channel(s) associated with the UE. A QCL type can correspond to quasi co-location (QCL) over two different types of reference signal (RS). The QCL type based on FD correlation can correspond to quasi co-location over a first type of reference signal (e.g., TRS and/or multi-port TRS, etc.) and a second type of reference signal (e.g., precoded DMRS). For example, the FD correlation-based QCL type configured for TRS and precoded DMRS can be used based on the TRS and precoded DMRS sharing a common FD correlation property. In some examples, one or more additional QCL relationships can be configured by a network entity (e.g., base station, gNB, etc.) between each of the N-port TRS (e.g., each of the multi-port TRS) and the associated DMRS port (or DMRS port group) of precoded control/data channels (e.g., as precoding may be applied to both control and data channels).

In some cases, the additional QCL type can be a QCL type that is based on FD correlation for the multi-port TRS. In some aspects, the additional QCL type can be a QCL type that is based on PDP estimation for the multi-port TRS. In one illustrative example, the FD correlation-based QCL type and/or the PDP estimation-based QCL type can be configured for QCL between a TRS port and DMRS. Different QCL relationships may be configured and/or indicated by the network entity between each TRS port of an N-port (e.g., multi-port) TRS configuration and/or TRS group, and the associated DMRS port or DMRS port group of precoded control/data channels.

For example, in a 2-port TRS group (e.g., an N-port TRS group with N=2), a first TRS port X can be QCL'ed with precoded DMRS corresponding to the strongest eigenmode, based on a similarity in FD correlation between the first TRS port X and the precoded DMRS corresponding to the strongest eigenmode. A second TRS port Y (e.g., different from the TRS port X) can be QCL'ed with precoded DMRS associated with a weaker (or weakest) eigenmode, based on a relative lack of similarity in FD correlation between the second TRS port Y and the precoded DMRS associated with the weaker (or weakest) eigenmode.

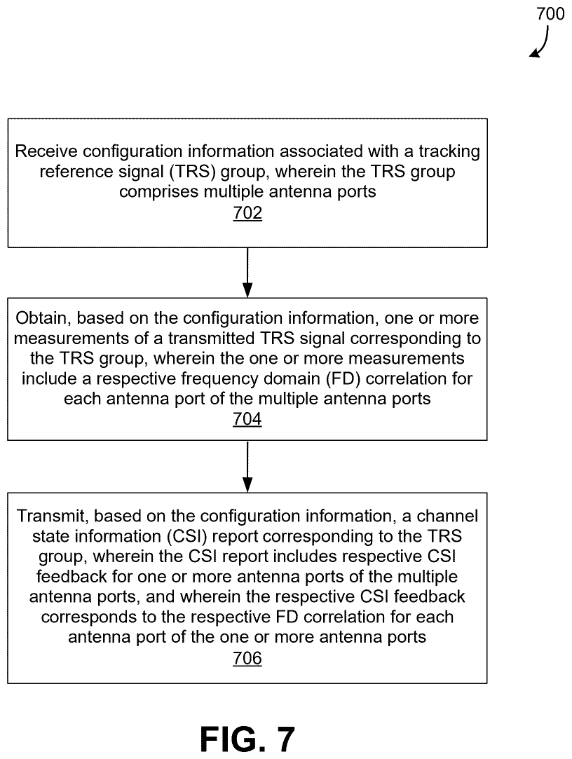

FIG. 7 is a flowchart diagram illustrating an example of a process 700 for wireless communications. In some aspects, the process 700 can be a process for wireless communications by a network entity (e.g., a UE, etc.). For example, the process 700 can be a process for wireless communications by a UE. In some examples, the process 700 can be performed by a network entity or network device (or apparatus) or a component (e.g., a chipset, codec, etc.) of the network entity or device. The process 700 can be performed by one or more processors such as one or more CPUs, DSPs, NPUs, NSPs, microcontrollers, ASICs, FPGAs, programmable logic devices, discrete gates or transistor logic components, discrete hardware components, etc., any combination thereof, and/or other component or system) of the network entity or device or apparatus. The operations of the process 700 may be implemented as software components that are executed and run on one or more processors (e.g., processor 810 and/or processing system 802 of FIG. 8, or other processor(s)).

In some examples, the process 700 can be performed by a UE, including any of the various UEs described herein. In some aspects, the process 700 can be performed by a UE, smartphone, mobile computing device, user computer device, etc. The process 700 can be performed by a component or system (e.g., a chipset) of a network device (e.g., one or more of UEs 104, 152, 164, 182, 190 of FIG. 1; UE 104 of FIG. 2; UE(s) 104 of FIG. 3; wireless device 407 of FIG. 4; computing system 800 and/or processing system 802 of FIG. 8; etc.). The network device may be a mobile device (e.g., a mobile phone), a network-connected wearable such as a watch, an extended reality (XR) device such as a virtual reality (VR) device or augmented reality (AR) device, a vehicle or component or system of a vehicle, or other type of computing device. The operations of the process 700 may be implemented as software components that are executed and run on one or more processors (e.g., the transmit processor 264, the receive processor 258, the TX MIMO processor 266, the MIMO detector 256 of FIG. 2, the processing system 470 of FIG. 4, the processor(s) 484 of FIG. 4, the processing system 802 of FIG. 8, and/or the processor 810 of FIG. 8, or other processor(s) (e.g., such as one or more other processors included within and/or associated with the processing system 470 of FIG. 4, the processing system 802 of FIG. 8, etc.). Further, the transmission and reception of signals by the network entity in the process 700 may be enabled, for example, by one or more antennas, one or more transceivers (e.g., wireless transceiver(s)), and/or other communication components (e.g., the transmit processor 264, the receive processor 258, the TX MIMO processor 266, the MIMO detector 256, the modulator(s)/demodulator(s) 254a through 254t, and/or the antenna(es) 252a through 252t of FIG. 2, the antenna(es) 487 of FIG. 4, the wireless transceiver(s) 478 of FIG. 4, the communication interface 840 of FIG. 8, or other antennae(s), transceiver(s), and/or component(s)).

At block 702, the network entity (or component thereof) can receive configuration information associated with a tracking reference signal (TRS) group, wherein the TRS group comprises multiple antenna ports. In some examples, the network entity can be a UE, including any of the UEs of FIGS. 1-6. In some examples, the TRS group can be an N-port TRS group including a quantity N of multiple antenna ports. In some cases, the TRS group can be a TRS group the same as or similar to the 2-port TRS group of FIG. 6A, comprising the multiple antenna ports Port X 612 and Port Y 622. In another example, the TRS group can be a TRS group the same as or similar to the 2-port TRS group of FIG. 6B, comprising the multiple antenna ports Port X 662 and Port Y 672.

In some cases, the configuration information can comprise a multi-modal TRS configuration for the TRS group. For example, an N-port TRS group can be configured by an additional network entity (e.g., base station, gNB, etc.). In some cases, to receive the configuration information, the network entity (or component thereof) can be configured to receive signaling indicative of the configuration information, wherein the signaling comprises at least one of: a radio resource control (RRC) message or system information (SI).

In some cases, the N-port TRS group can be configured by an additional network entity via RRC and/or SI, and the N-port TRS group may subsequently be activated by a MAC-CE or DCI from the additional network entity. For example, the network entity (or component thereof) can be configured to receive a media access control (MAC) control element (CE) (MAC-CE) or downlink control information (DCI) indicative of activation of the multi-modal TRS configuration. The network entity (or component thereof) can obtain the one or more measurements of the transmitted TRS signal corresponding to the TRS group based on the activation of the multi-modal TRS configuration.

In some examples the configuration information can be indicative of a symbol mapping configuration between the multiple antenna ports and a set of symbols. For example, each antenna port of the multiple antenna ports can be mapped to a corresponding symbol of the set of symbols according to the symbol mapping configuration. In some cases, the symbol mapping configuration is a consecutive symbol mapping configuration, where the corresponding symbols of the set of symbols are consecutive in a time domain. For example, the symbol mapping configuration can be a consecutive symbol mapping configuration corresponding to the example consecutive symbol mapping configuration 600 of FIG. 6A.

In some cases, the symbol mapping configuration can be a distributed symbol mapping configuration, where the corresponding symbols of the set of symbols are separated by one or more slots in a time domain. For example, the symbol mapping configuration can be a distributed symbol mapping configuration corresponding to the example distributed symbol mapping configuration 650 of FIG. 6B. In some examples, the configuration information can be indicative of a frequency domain correlation-based quasi colocation (QCL) between an antenna port of the multiple antenna ports and a demodulation reference signal (DMRS) of a precoded data channel.

At block 704, the network entity (or component thereof) can obtain, based on the configuration information, one or more measurements of a transmitted TRS signal corresponding to the TRS group, wherein the one or more measurements include a respective frequency domain (FD) correlation for each antenna port of the multiple antenna ports.

For example, the configuration information can cause the network entity (or component thereof) to obtain the one or more measurements of the transmitted TRS signal using a configured frequency density and/or a configured bandwidth allocation for each TRS port of the multiple TRS ports included within the TRS group. In some examples, within the TRS group, the frequency density and/or bandwidth allocation of each TRS antenna port can be jointly configured with one or more additional TRS antenna ports of the TRS group, or can be separately configured apart from the remaining TRS antenna ports of the TRS group.

In some examples, the configuration information can be indicative of a joint configuration for the TRS group. To obtain the one or more measurements of the transmitted TRS signal, the network entity (or component thereof) can be configured to obtain respective measurements for each antenna port of the multiple antenna ports using the joint configuration.

In some examples, the configuration information can be indicative of a respective configuration for each antenna port of the multiple antenna ports. To obtain the one or more measurements of the transmitted TRS signal, the network entity (or component thereof) can be configured to obtain a respective measurement for each antenna port of the multiple antenna ports using the respective configuration.

At block 706, the network entity (or component thereof) can transmit, based on the configuration information, a channel state information (CSI) report corresponding to the TRS group, wherein the CSI report includes respective CSI feedback for one or more antenna ports of the multiple antenna ports, and wherein the respective CSI feedback corresponds to the respective FD correlation for each antenna port of the one or more antenna ports.

In some examples, the CSI report corresponding to the TRS group can be associated with a first priority value. A second CSI report corresponding to at least one of precoding matrix indicator (PMI) information, rank indicator (RI) information, or channel quality indicator (CQI) information can be associated with a second priority value. The first priority value can be greater than or equal to the second priority value. Based on the first priority value being greater than or equal to the second priority value, the network entity (or component thereof) can be configured to generate and transmit the CSI report corresponding to the TRS group, before generating and/or transmitting the second CSI report for the PMI information, RI information, and/or CQI information.

In some cases, the network entity (or component thereof) can be configured to transmit the CSI report corresponding to the TRS group before the second CSI report, the second CSI report corresponding to at least one of precoding matrix indicator (PMI) information, rank indicator (RI) information, or channel quality indicator (CQI) information.

In some examples the respective CSI feedback for an antenna port of the multiple antenna ports may be indicative of a quantized FD correlation of the antenna port over a reduced bandwidth, and the reduced bandwidth can be determined based on the configuration information. In some cases, the respective CSI feedback for an antenna port of the multiple antenna ports may be indicative of a power delay profile (PDP) window size determined from the respective FD correlation for the antenna port. In some examples, the respective CSI feedback for an antenna port of the multiple antenna ports can be indicative of a percentage of the respective FD correlation for the antenna port greater than a configured threshold, where the configuration information is indicative of the configured threshold.

In some examples, the processes described herein (e.g., process 700 and/or other process described herein) may be performed by a computing device or apparatus (e.g., a network node such as a UE, base station, a portion of a base station, etc.). For example, as noted above, the process 700 may be performed by a UE and/or network entity (e.g., base station, gNB, etc.). In some examples, the process 700 may be performed by a computing device with the computing system 800 shown in FIG. 8. For example, a wireless communication device with the computing architecture shown in FIG. 8 may include the components of the UE and/or the network entity (e.g., base station, gNB, etc.) and may implement the operations of FIG. 7 and/or process 700, etc.

In some cases, the computing device or apparatus may include various components, such as one or more input devices, one or more output devices, one or more processors, one or more microprocessors, one or more microcomputers, one or more cameras, one or more sensors, and/or other component(s) that are configured to carry out the steps of processes described herein. In some examples, the computing device may include a display, one or more network interfaces configured to communicate and/or receive the data, any combination thereof, and/or other component(s). The one or more network interfaces may be configured to communicate and/or receive wired and/or wireless data, including data according to the 3G, 4G, 5G, and/or other cellular standard, data according to the WiFi (802.11x) standards, data according to the Bluetooth™ standard, data according to the Internet Protocol (IP) standard, and/or other types of data.

The components of the computing device may be implemented in circuitry. For example, the components may include and/or may be implemented using electronic circuits or other electronic hardware, which may include one or more programmable electronic circuits (e.g., microprocessors, graphics processing units (GPUs), digital signal processors (DSPs), central processing units (CPUs), and/or other suitable electronic circuits), and/or may include and/or be implemented using computer software, firmware, or any combination thereof, to perform the various operations described herein.

The process 700 is illustrated as a logical flow diagram, the operation of which represents a sequence of operations that may be implemented in hardware, computer instructions, or a combination thereof. In the context of computer instructions, the operations represent computer-executable instructions stored on one or more computer-readable storage media that, when executed by one or more processors, perform the recited operations. Generally, computer-executable instructions include routines, programs, objects, components, data structures, and the like that perform particular functions or implement particular data types. The order in which the operations are described is not intended to be construed as a limitation, and any number of the described operations may be combined in any order and/or in parallel to implement the processes.

Additionally, the process 700 and/or other process described herein may be performed under the control of one or more computer systems configured with executable instructions and may be implemented as code (e.g., executable instructions, one or more computer programs, or one or more applications) executing collectively on one or more processors, by hardware, or combinations thereof. As noted above, the code may be stored on a computer-readable or machine-readable storage medium, for example, in the form of a computer program comprising a plurality of instructions executable by one or more processors. The computer-readable or machine-readable storage medium may be non-transitory.

FIG. 8 is a diagram illustrating an example of a system for implementing certain aspects of the present technology. In particular, FIG. 8 illustrates an example of computing system 800 including a processing system 802, which may be for example any computing device making up internal computing system, a remote computing system, a camera, or any component thereof in which the components of the system are in communication with each other using connection 805. Connection 805 may be a physical connection using a bus, or a direct connection into processor 810 (and/or one or more other processors included within and/or associated with the processing system 802), such as in a chipset architecture. Connection 805 may also be a virtual connection, networked connection, or logical connection.

In some aspects, computing system 800 and/or the processing system 802 can be provided as a distributed system in which the functions described in this disclosure may be distributed within a datacenter, multiple data centers, a peer network, etc. In some aspects, one or more of the described system components represents many such components each performing some or all of the function for which the component is described. In some aspects, the components may be physical or virtual devices.

The example processing system 802 includes at least one processing unit (CPU or processor) 810 and connection 805 that communicatively couples various system components including system memory 815, such as read-only memory (ROM) 820 and random access memory (RAM) 825 to processor 810. The processing system 802 may include a cache 812 of high-speed memory connected directly with, in close proximity to, or integrated as part of processor 810 and/or one or more other processors included within and/or associated with the processing system 802.

Processor 810 may include any general-purpose processor and a hardware service or software service, such as services 832, 834, and 836 stored in storage device 830, configured to control processor 810 and/or one or more other processors included within and/or associated with the processing system 802, as well as a special-purpose processor where software instructions are incorporated into the actual processor design. Processor 810 may essentially be a completely self-contained computing system, containing multiple cores or processors, a bus, memory controller, cache, etc. A multi-core processor may be symmetric or asymmetric.

To enable user interaction, processing system 802 includes an input device 845, which may represent any number of input mechanisms, such as a microphone for speech, a touch-sensitive screen for gesture or graphical input, keyboard, mouse, motion input, speech, etc. Processing system 802 may also include output device 835, which may be one or more of a number of output mechanisms. In some examples, multimodal systems may enable a user to provide multiple types of input/output to communicate with processing system 802.

Processing system 802 may include communications interface 840, which may generally govern and manage the user input and system output. The communication interface may perform or facilitate receipt and/or transmission wired or wireless communications using wired and/or wireless transceivers, including those making use of an audio jack/plug, a microphone jack/plug, a universal serial bus (USB) port/plug, an Apple™ Lightning™ port/plug, an Ethernet port/plug, a fiber optic port/plug, a proprietary wired port/plug, 3G, 4G, 5G and/or other cellular data network wireless signal transfer, a Bluetooth™ wireless signal transfer, a Bluetooth™ low energy (BLE) wireless signal transfer, an IBEACON™ wireless signal transfer, a radio-frequency identification (RFID) wireless signal transfer, near-field communications (NFC) wireless signal transfer, dedicated short range communication (DSRC) wireless signal transfer, 802.11 Wi-Fi wireless signal transfer, wireless local area network (WLAN) signal transfer, Visible Light Communication (VLC), Worldwide Interoperability for Microwave Access (WiMAX), Infrared (IR) communication wireless signal transfer, Public Switched Telephone Network (PSTN) signal transfer, Integrated Services Digital Network (ISDN) signal transfer, ad-hoc network signal transfer, radio wave signal transfer, microwave signal transfer, infrared signal transfer, visible light signal transfer, ultraviolet light signal transfer, wireless signal transfer along the electromagnetic spectrum, or some combination thereof. The communications interface 840 may also include one or more Global Navigation Satellite System (GNSS) receivers or transceivers that are used to determine a location of the computing system 800 based on receipt of one or more signals from one or more satellites associated with one or more GNSS systems. GNSS systems include, but are not limited to, the US-based Global Positioning System (GPS), the Russia-based Global Navigation Satellite System (GLONASS), the China-based BeiDou Navigation Satellite System (BDS), and the Europe-based Galileo GNSS. There is no restriction on operating on any particular hardware arrangement, and therefore the basic features here may easily be substituted for improved hardware or firmware arrangements as they are developed.

Storage device 830 may be a non-volatile and/or non-transitory and/or computer-readable memory device and may be a hard disk or other types of computer readable media which may store data that are accessible by a computer, such as magnetic cassettes, flash memory cards, solid state memory devices, digital versatile disks, cartridges, a floppy disk, a flexible disk, a hard disk, magnetic tape, a magnetic strip/stripe, any other magnetic storage medium, flash memory, memristor memory, any other solid-state memory, a compact disc read only memory (CD-ROM) optical disc, a rewritable compact disc (CD) optical disc, digital video disk (DVD) optical disc, a blu-ray disc (BDD) optical disc, a holographic optical disk, another optical medium, a secure digital (SD) card, a micro secure digital (microSD) card, a Memory Stick® card, a smartcard chip, a EMV chip, a subscriber identity module (SIM) card, a mini/micro/nano/pico SIM card, another integrated circuit (IC) chip/card, random access memory (RAM), static RAM (SRAM), dynamic RAM (DRAM), read-only memory (ROM), programmable read-only memory (PROM), erasable programmable read-only memory (EPROM), electrically erasable programmable read-only memory (EEPROM), flash EPROM (FLASHEPROM), cache memory (e.g., Level 1 (L1) cache, Level 2 (L2) cache, Level 3 (L3) cache, Level 4 (L4) cache, Level 5 (L5) cache, or other (L #) cache), resistive random-access memory (RRAM/ReRAM), phase change memory (PCM), spin transfer torque RAM (STT-RAM), another memory chip or cartridge, and/or a combination thereof.

The storage device 830 may include software services, servers, services, etc., that when the code that defines such software is executed by the processor 810 and/or one or more other processors included within and/or associated with the processing system 802, it causes the system to perform a function. In some aspects, a hardware service that performs a particular function may include the software component stored in a computer-readable medium in connection with the necessary hardware components, such as processor 810 (e.g., and/or one or more other processors included within and/or associated with the processing system 802), connection 805, output device 835, etc., to carry out the function. The term “computer-readable medium” includes, but is not limited to, portable or non-portable storage devices, optical storage devices, and various other mediums capable of storing, containing, or carrying instruction(s) and/or data. A computer-readable medium may include a non-transitory medium in which data may be stored and that does not include carrier waves and/or transitory electronic signals propagating wirelessly or over wired connections. Examples of a non-transitory medium may include, but are not limited to, a magnetic disk or tape, optical storage media such as compact disk (CD) or digital versatile disk (DVD), flash memory, memory or memory devices. A computer-readable medium may have stored thereon code and/or machine-executable instructions that may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc., may be passed, forwarded, or transmitted via any suitable means including memory sharing, message passing, token passing, network transmission, or the like.

Specific details are provided in the description above to provide a thorough understanding of the aspects and examples provided herein, but those skilled in the art will recognize that the application is not limited thereto. Thus, while illustrative aspects of the application have been described in detail herein, it is to be understood that the inventive concepts may be otherwise variously embodied and employed, and that the appended claims are intended to be construed to include such variations, except as limited by the prior art. Various features and aspects of the above-described application may be used individually or jointly. Further, aspects may be utilized in any number of environments and applications beyond those described herein without departing from the broader scope of the specification. The specification and drawings are, accordingly, to be regarded as illustrative rather than restrictive. For the purposes of illustration, methods were described in a particular order. It should be appreciated that in alternate aspects, the methods may be performed in a different order than that described.

For clarity of explanation, in some examples the present technology may be presented as including individual functional blocks comprising devices, device components, steps or routines in a method embodied in software, or combinations of hardware and software. Additional components may be used other than those shown in the figures and/or described herein. For example, circuits, systems, networks, processes, and other components may be shown as components in block diagram form in order not to obscure the aspects in unnecessary detail. In other examples, well-known circuits, processes, algorithms, structures, and techniques may be shown without unnecessary detail in order to avoid obscuring the aspects.

Further, those of skill in the art will appreciate that the various illustrative logical blocks, modules, circuits, and algorithm steps described in connection with the aspects disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

Individual aspects may be described above as a process or method which is depicted as a flowchart, a flow diagram, a data flow diagram, a structure diagram, or a block diagram. Although a flowchart may describe the operations as a sequential process, many of the operations may be performed in parallel or concurrently. In addition, the order of the operations may be re-arranged. A process is terminated when its operations are completed, but could have additional steps not included in a figure. A process may correspond to a method, a function, a procedure, a subroutine, a subprogram, etc. When a process corresponds to a function, its termination may correspond to a return of the function to the calling function or the main function.

Processes and methods according to the above-described examples may be implemented using computer-executable instructions that are stored or otherwise available from computer-readable media. Such instructions may include, for example, instructions and data which cause or otherwise configure a general purpose computer, special purpose computer, or a processing device to perform a certain function or group of functions. Portions of computer resources used may be accessible over a network. The computer executable instructions may be, for example, binaries, intermediate format instructions such as assembly language, firmware, source code. Examples of computer-readable media that may be used to store instructions, information used, and/or information created during methods according to described examples include magnetic or optical disks, flash memory, USB devices provided with non-volatile memory, networked storage devices, and so on.

In some aspects the computer-readable storage devices, mediums, and memories may include a cable or wireless signal containing a bitstream and the like. However, when mentioned, non-transitory computer-readable storage media expressly exclude media such as energy, carrier signals, electromagnetic waves, and signals per se.

Those of skill in the art will appreciate that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof, in some cases depending in part on the particular application, in part on the desired design, in part on the corresponding technology, etc.

The various illustrative logical blocks, modules, and circuits described in connection with the aspects disclosed herein may be implemented or performed using hardware, software, firmware, middleware, microcode, hardware description languages, or any combination thereof, and may take any of a variety of form factors. When implemented in software, firmware, middleware, or microcode, the program code or code segments to perform the necessary tasks (e.g., a computer-program product) may be stored in a computer-readable or machine-readable medium. A processor(s) may perform the necessary tasks. Examples of form factors include laptops, smart phones, mobile phones, tablet devices or other small form factor personal computers, personal digital assistants, rackmount devices, standalone devices, and so on. Functionality described herein also may be embodied in peripherals or add-in cards. Such functionality may also be implemented on a circuit board among different chips or different processes executing in a single device, by way of further example.

The instructions, media for conveying such instructions, computing resources for executing them, and other structures for supporting such computing resources are example means for providing the functions described in the disclosure.

The techniques described herein may also be implemented in electronic hardware, computer software, firmware, or any combination thereof. Such techniques may be implemented in any of a variety of devices such as general purposes computers, wireless communication device handsets, or integrated circuit devices having multiple uses including application in wireless communication device handsets and other devices. Any features described as modules or components may be implemented together in an integrated logic device or separately as discrete but interoperable logic devices. If implemented in software, the techniques may be realized at least in part by a computer-readable data storage medium comprising program code including instructions that, when executed, performs one or more of the methods, algorithms, and/or operations described above. The computer-readable data storage medium may form part of a computer program product, which may include packaging materials. The computer-readable medium may comprise memory or data storage media, such as random access memory (RAM) such as synchronous dynamic random access memory (SDRAM), read-only memory (ROM), non-volatile random access memory (NVRAM), electrically erasable programmable read-only memory (EEPROM), FLASH memory, magnetic or optical data storage media, and the like. The techniques additionally, or alternatively, may be realized at least in part by a computer-readable communication medium that carries or communicates program code in the form of instructions or data structures and that may be accessed, read, and/or executed by a computer, such as propagated signals or waves.

The program code may be executed by a processor, which may include one or more processors, such as one or more digital signal processors (DSPs), general purpose microprocessors, an application specific integrated circuits (ASICs), field programmable logic arrays (FPGAs), or other equivalent integrated or discrete logic circuitry. Such a processor may be configured to perform any of the techniques described in this disclosure. A general-purpose processor may be a microprocessor; but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Accordingly, the term “processor,” as used herein may refer to any of the foregoing structure, any combination of the foregoing structure, or any other structure or apparatus suitable for implementation of the techniques described herein.

One of ordinary skill will appreciate that the less than (“<”) and greater than (“>”) symbols or terminology used herein may be replaced with less than or equal to (“≤”) and greater than or equal to (“≥”) symbols, respectively, without departing from the scope of this description.

Where components are described as being “configured to” perform certain operations, such configuration may be accomplished, for example, by designing electronic circuits or other hardware to perform the operation, by programming programmable electronic circuits (e.g., microprocessors, or other suitable electronic circuits) to perform the operation, or any combination thereof.

The phrase “coupled to” or “communicatively coupled to” refers to any component that is physically connected to another component either directly or indirectly, and/or any component that is in communication with another component (e.g., connected to the other component over a wired or wireless connection, and/or other suitable communication interface) either directly or indirectly.

Claim language or other language reciting “at least one of” a set and/or “one or more” of a set indicates that one member of the set or multiple members of the set (in any combination) satisfy the claim. For example, claim language reciting “at least one of A and B” or “at least one of A or B” means A, B, or A and B. In another example, claim language reciting “at least one of A, B, and C” or “at least one of A, B, or C” means A, B, C, or A and B, or A and C, or B and C, A and B and C, or any duplicate information or data (e.g., A and A, B and B, C and C, A and A and B, and so on), or any other ordering, duplication, or combination of A, B, and C. The language “at least one of” a set and/or “one or more” of a set does not limit the set to the items listed in the set. For example, claim language reciting “at least one of A and B” or “at least one of A or B” may mean A, B, or A and B, and may additionally include items not listed in the set of A and B.

Claim language or other language reciting “at least one processor configured to,” “at least one processor being configured to,” or the like indicates that one processor or multiple processors (in any combination) can perform the associated operation(s). For example, claim language reciting “at least one processor configured to: X, Y, and Z” means a single processor can be used to perform operations X, Y, and Z; or that multiple processors are each tasked with a certain subset of operations X, Y, and Z such that together the multiple processors perform X, Y, and Z; or that a group of multiple processors work together to perform operations X, Y, and Z. In another example, claim language reciting “at least one processor configured to: X, Y, and Z” can mean that any single processor may only perform at least a subset of operations X, Y, and Z.

Where reference is made to one or more elements performing functions (e.g., steps of a method), one element may perform all functions, or more than one element may collectively perform the functions. When more than one element collectively performs the functions, each function need not be performed by each of those elements (e.g., different functions may be performed by different elements) and/or each function need not be performed in whole by only one element (e.g., different elements may perform different sub-functions of a function). Similarly, where reference is made to one or more elements configured to cause another element (e.g., an apparatus) to perform functions, one element may be configured to cause the other element to perform all functions, or more than one element may collectively be configured to cause the other element to perform the functions.

Where reference is made to an entity (e.g., any entity or device described herein) performing functions or being configured to perform functions (e.g., steps of a method), the entity may be configured to cause one or more elements (individually or collectively) to perform the functions. The one or more components of the entity may include at least one memory, at least one processor, at least one communication interface, another component configured to perform one or more (or all) of the functions, and/or any combination thereof. Where reference to the entity performing functions, the entity may be configured to cause one component to perform all functions, or to cause more than one component to collectively perform the functions. When the entity is configured to cause more than one component to collectively perform the functions, each function need not be performed by each of those components (e.g., different functions may be performed by different components) and/or each function need not be performed in whole by only one component (e.g., different components may perform different sub-functions of a function).

Illustrative aspects of the disclosure include:
Aspect 1. A network entity for wireless communication, comprising: a processing system configured to: receive configuration information associated with a tracking reference signal (TRS) group, wherein the TRS group comprises multiple antenna ports; obtain, based on the configuration information, one or more measurements of a transmitted TRS signal corresponding to the TRS group, wherein the one or more measurements include a respective frequency domain (FD) correlation for each antenna port of the multiple antenna ports; and transmit, based on the configuration information, a channel state information (CSI) report corresponding to the TRS group, wherein the CSI report includes respective CSI feedback for one or more antenna ports of the multiple antenna ports, and wherein the respective CSI feedback corresponds to the respective FD correlation for each antenna port of the one or more antenna ports.
Aspect 2. The network entity of Aspect 1, wherein: the CSI report corresponding to the TRS group is associated with a first priority value; a second CSI report corresponding to at least one of precoding matrix indicator (PMI) information, rank indicator (RI) information, or channel quality indicator (CQI) information is associated with a second priority value; and the first priority value is greater than or equal to the second priority value.
Aspect 3. The network entity of any of Aspects 1 to 2, wherein the processing system is configured to transmit the CSI report corresponding to the TRS group before a second CSI report, the second CSI report corresponding to at least one of precoding matrix indicator (PMI) information, rank indicator (RI) information, or channel quality indicator (CQI) information.
Aspect 4. The network entity of any of Aspects 1 to 3, wherein: the configuration information comprises a multi-modal TRS configuration for the TRS group; and to receive the configuration information, the processing system is configured to receive signaling indicative of the configuration information, wherein the signaling comprises at least one of: a radio resource control (RRC) message or system information (SI).
Aspect 5. The network entity of Aspect 4, wherein the processing system is configured to: receive a media access control (MAC) control element (CE) (MAC-CE) or downlink control information (DCI) indicative of activation of the multi-modal TRS configuration; and obtain the one or more measurements of the transmitted TRS signal corresponding to the TRS group based on the activation of the multi-modal TRS configuration.
Aspect 6. The network entity of any of Aspects 1 to 5, wherein the configuration information is indicative of a symbol mapping configuration between the multiple antenna ports and a set of symbols, wherein each antenna port of the multiple antenna ports is mapped to a corresponding symbol of the set of symbols according to the symbol mapping configuration.
Aspect 7. The network entity of Aspect 6, wherein the symbol mapping configuration is a consecutive symbol mapping configuration, wherein the corresponding symbols of the set of symbols are consecutive in a time domain.
Aspect 8. The network entity of any of Aspects 6 to 7, wherein the symbol mapping configuration is a distributed symbol mapping configuration, wherein the corresponding symbols of the set of symbols are separated by one or more slots in a time domain.
Aspect 9. The network entity of any of Aspects 1 to 8, wherein: the configuration information is indicative of a joint configuration for the TRS group; and to obtain the one or more measurements of the transmitted TRS signal, the processing system is configured to obtain respective measurements for each antenna port of the multiple antenna ports using the joint configuration.
Aspect 10. The network entity of any of Aspects 1 to 9, wherein: the configuration information is indicative of a respective configuration for each antenna port of the multiple antenna ports; and to obtain the one or more measurements of the transmitted TRS signal, the processing system is configured to obtain a respective measurement for each antenna port of the multiple antenna ports using the respective configuration.
Aspect 11. The network entity of any of Aspects 1 to 10, wherein the respective CSI feedback for an antenna port of the multiple antenna ports is indicative of a quantized FD correlation of the antenna port over a reduced bandwidth, and wherein the reduced bandwidth is determined based on the configuration information.
Aspect 12. The network entity of any of Aspects 1 to 11, wherein the respective CSI feedback for an antenna port of the multiple antenna ports is indicative of a power delay profile (PDP) window size determined from the respective FD correlation for the antenna port.
Aspect 13. The network entity of any of Aspects 1 to 12, wherein the respective CSI feedback for an antenna port of the multiple antenna ports is indicative of a percentage of the respective FD correlation for the antenna port greater than a configured threshold, and wherein the configuration information is indicative of the configured threshold.
Aspect 14. The network entity of any of Aspects 1 to 13, wherein the configuration information is indicative of a frequency domain correlation-based quasi colocation (QCL) between an antenna port of the multiple antenna ports and a demodulation reference signal (DMRS) of a precoded data channel.
Aspect 15. The network entity of any of Aspects 1 to 14, wherein the network entity is a user equipment (UE).
Aspect 16. A method for wireless communication, comprising: receiving configuration information associated with a tracking reference signal (TRS) group, wherein the TRS group comprises multiple antenna ports; obtaining, based on the configuration information, one or more measurements of a transmitted TRS signal corresponding to the TRS group, wherein the one or more measurements include a respective frequency domain (FD) correlation for each antenna port of the multiple antenna ports; and transmitting, based on the configuration information, a channel state information (CSI) report corresponding to the TRS group, wherein the CSI report includes respective CSI feedback for one or more antenna ports of the multiple antenna ports, and wherein the respective CSI feedback corresponds to the respective FD correlation for each antenna port of the one or more antenna ports.
Aspect 17. The method of Aspect 16, wherein: the CSI report corresponding to the TRS group is associated with a first priority value; a second CSI report corresponding to at least one of precoding matrix indicator (PMI) information, rank indicator (RI) information, or channel quality indicator (CQI) information is associated with a second priority value; and the first priority value is greater than or equal to the second priority value.
Aspect 18. The method of any of Aspects 16 to 17, further comprising transmitting the CSI report corresponding to the TRS group before a second CSI report, the second CSI report corresponding to at least one of precoding matrix indicator (PMI) information, rank indicator (RI) information, or channel quality indicator (CQI) information.
Aspect 19. The method of any of Aspects 16 to 18, wherein: the configuration information comprises a multi-modal TRS configuration for the TRS group; and receiving the configuration information comprises receiving signaling indicative of the configuration information, wherein the signaling comprises at least one of: a radio resource control (RRC) message or system information (SI).
Aspect 20. The method of Aspect 19, further comprising: receiving a media access control (MAC) control element (CE) (MAC-CE) or downlink control information (DCI) indicative of activation of the multi-modal TRS configuration; and obtaining the one or more measurements of the transmitted TRS signal corresponding to the TRS group based on the activation of the multi-modal TRS configuration.
Aspect 21. The method of any of Aspects 16 to 20, wherein the configuration information is indicative of a symbol mapping configuration between the multiple antenna ports and a set of symbols, wherein each antenna port of the multiple antenna ports is mapped to a corresponding symbol of the set of symbols according to the symbol mapping configuration.
Aspect 22. The method of Aspect 21, wherein the symbol mapping configuration is a consecutive symbol mapping configuration, wherein the corresponding symbols of the set of symbols are consecutive in a time domain.
Aspect 23. The method of any of Aspects 21 to 22, wherein the symbol mapping configuration is a distributed symbol mapping configuration, wherein the corresponding symbols of the set of symbols are separated by one or more slots in a time domain.
Aspect 24. The method of any of Aspects 16 to 23, wherein: the configuration information is indicative of a joint configuration for the TRS group; and obtaining the one or more measurements of the transmitted TRS signal comprises obtaining respective measurements for each antenna port of the multiple antenna ports using the joint configuration.
Aspect 25. The method of any of Aspects 16 to 24, wherein: the configuration information is indicative of a respective configuration for each antenna port of the multiple antenna ports; and obtaining the one or more measurements of the transmitted TRS signal comprises obtaining a respective measurement for each antenna port of the multiple antenna ports using the respective configuration.
Aspect 26. The method of any of Aspects 16 to 25, wherein the respective CSI feedback for an antenna port of the multiple antenna ports is indicative of a quantized FD correlation of the antenna port over a reduced bandwidth, and wherein the reduced bandwidth is determined based on the configuration information.
Aspect 27. The method of any of Aspects 16 to 26, wherein the respective CSI feedback for an antenna port of the multiple antenna ports is indicative of a power delay profile (PDP) window size determined from the respective FD correlation for the antenna port.
Aspect 28. The method of any of Aspects 16 to 27, wherein the respective CSI feedback for an antenna port of the multiple antenna ports is indicative of a percentage of the respective FD correlation for the antenna port greater than a configured threshold, and wherein the configuration information is indicative of the configured threshold.
Aspect 29. The method of any of Aspects 16 to 28, wherein the configuration information is indicative of a frequency domain correlation-based quasi colocation (QCL) between an antenna port of the multiple antenna ports and a demodulation reference signal (DMRS) of a precoded data channel.
Aspect 30. A non-transitory computer-readable storage medium comprising instructions stored thereon which, when executed by at least one processor, causes the at least one processor to perform operations according to any of Aspects 1 to 15.
Aspect 31. An apparatus for wireless communication comprising one or more means for performing operations according to any of Aspects 1 to 15.

What is claimed is:

1. A network entity for wireless communication, comprising:
a processing system configured to:
receive configuration information associated with a tracking reference signal (TRS) group, wherein the TRS group comprises multiple antenna ports;
obtain, based on the configuration information, one or more measurements of a transmitted TRS signal corresponding to the TRS group, wherein the one or more measurements include a respective frequency domain (FD) correlation for each antenna port of the multiple antenna ports; and
transmit, based on the configuration information, a channel state information (CSI) report corresponding to the TRS group, wherein the CSI report includes respective CSI feedback for one or more antenna ports of the multiple antenna ports, and wherein the respective CSI feedback corresponds to the respective FD correlation for each antenna port of the one or more antenna ports.

2. The network entity of claim 1, wherein:
the CSI report corresponding to the TRS group is associated with a first priority value;
a second CSI report corresponding to at least one of precoding matrix indicator (PMI) information, rank indicator (RI) information, or channel quality indicator (CQI) information is associated with a second priority value; and
the first priority value is greater than or equal to the second priority value.

3. The network entity of claim 1, wherein the processing system is configured to transmit the CSI report corresponding to the TRS group before a second CSI report, the second CSI report corresponding to at least one of precoding matrix indicator (PMI) information, rank indicator (RI) information, or channel quality indicator (CQI) information.

4. The network entity of claim 1, wherein:
the configuration information comprises a multi-modal TRS configuration for the TRS group; and
to receive the configuration information, the processing system is configured to receive signaling indicative of the configuration information, wherein the signaling comprises at least one of: a radio resource control (RRC) message or system information (SI).

5. The network entity of claim 4, wherein the processing system is configured to:
receive a media access control (MAC) control element (CE) (MAC-CE) or downlink control information (DCI) indicative of activation of the multi-modal TRS configuration; and
obtain the one or more measurements of the transmitted TRS signal corresponding to the TRS group based on the activation of the multi-modal TRS configuration.

6. The network entity of claim 1, wherein the configuration information is indicative of a symbol mapping configuration between the multiple antenna ports and a set of symbols, wherein each antenna port of the multiple antenna ports is mapped to a corresponding symbol of the set of symbols according to the symbol mapping configuration.

7. The network entity of claim 6, wherein the symbol mapping configuration is a consecutive symbol mapping configuration, wherein the corresponding symbols of the set of symbols are consecutive in a time domain.

8. The network entity of claim 6, wherein the symbol mapping configuration is a distributed symbol mapping configuration, wherein the corresponding symbols of the set of symbols are separated by one or more slots in a time domain.

9. The network entity of claim 1, wherein:
the configuration information is indicative of a joint configuration for the TRS group; and
to obtain the one or more measurements of the transmitted TRS signal, the processing system is configured to obtain respective measurements for each antenna port of the multiple antenna ports using the joint configuration.

10. The network entity of claim 1, wherein:
the configuration information is indicative of a respective configuration for each antenna port of the multiple antenna ports; and
to obtain the one or more measurements of the transmitted TRS signal, the processing system is configured to obtain a respective measurement for each antenna port of the multiple antenna ports using the respective configuration.

11. The network entity of claim 1, wherein the respective CSI feedback for an antenna port of the multiple antenna ports is indicative of a quantized FD correlation of the antenna port over a reduced bandwidth, and wherein the reduced bandwidth is determined based on the configuration information.

12. The network entity of claim 1, wherein the respective CSI feedback for an antenna port of the multiple antenna ports is indicative of a power delay profile (PDP) window size determined from the respective FD correlation for the antenna port.

13. The network entity of claim 1, wherein the respective CSI feedback for an antenna port of the multiple antenna ports is indicative of a percentage of the respective FD correlation for the antenna port greater than a configured threshold, and wherein the configuration information is indicative of the configured threshold.

14. The network entity of claim 1, wherein the configuration information is indicative of a frequency domain correlation-based quasi colocation (QCL) between an antenna port of the multiple antenna ports and a demodulation reference signal (DMRS) of a precoded data channel.

15. The network entity of claim 1, wherein the network entity is a user equipment (UE).

16. A method for wireless communication, comprising:
receiving configuration information associated with a tracking reference signal (TRS) group, wherein the TRS group comprises multiple antenna ports;
obtaining, based on the configuration information, one or more measurements of a transmitted TRS signal corresponding to the TRS group, wherein the one or more measurements include a respective frequency domain (FD) correlation for each antenna port of the multiple antenna ports; and
transmitting, based on the configuration information, a channel state information (CSI) report corresponding to the TRS group, wherein the CSI report includes respective CSI feedback for one or more antenna ports of the multiple antenna ports, and wherein the respective CSI feedback corresponds to the respective FD correlation for each antenna port of the one or more antenna ports.

17. The method of claim 16, wherein:
the CSI report corresponding to the TRS group is associated with a first priority value;
a second CSI report corresponding to at least one of precoding matrix indicator (PMI) information, rank indicator (RI) information, or channel quality indicator (CQI) information is associated with a second priority value; and
the first priority value is greater than or equal to the second priority value.

18. The method of claim 16, further comprising transmitting the CSI report corresponding to the TRS group before a second CSI report, the second CSI report corresponding to at least one of precoding matrix indicator (PMI) information, rank indicator (RI) information, or channel quality indicator (CQI) information.

19. The method of claim 16, wherein:
the configuration information comprises a multi-modal TRS configuration for the TRS group; and
receiving the configuration information comprises receiving signaling indicative of the configuration information, wherein the signaling comprises at least one of: a radio resource control (RRC) message or system information (SI).

20. The method of claim 19, further comprising:
receiving a media access control (MAC) control element (CE) (MAC-CE) or downlink control information (DCI) indicative of activation of the multi-modal TRS configuration; and
obtaining the one or more measurements of the transmitted TRS signal corresponding to the TRS group based on the activation of the multi-modal TRS configuration.
